(19) United States
(12) Patent Application Publication
(10) Pub. No.: US 2024/0395520 A1
(43) Pub. Date: Nov. 28, 2024

(54) METHOD FOR CALIBRATING A TIME-OF-FLIGHT MASS ANALYSER AND TIME-OF-FLIGHT MASS ANALYSER

(71) Applicant: Thermo Fisher Scientific (Bremen) GmbH, Bremen (DE)

(72) Inventors: Hamish Stewart, Bremen (DE); Dmitry Grinfeld, Bremen (DE); Bernd Hagedorn, Bremen (DE); Alexander Makarov, Bremen (DE)

(73) Assignee: Thermo Fisher Scientific (Bremen) GmbH, Bremen (DE)

(21) Appl. No.: 18/671,642

(22) Filed: May 22, 2024

(30) Foreign Application Priority Data
May 23, 2023 (GB) 2307711.8

(51) Int. Cl. H01J 49/00; H01J 49/06; H01J 49/40

(52) U.S. Cl. CPC H01J 49/0009; H01J 49/06; H01J 49/40

(57) ABSTRACT

A method for calibrating a time-of-flight (ToF) mass analyser comprises an ion injection device and an ion mirror comprising a plurality of electrodes, comprising: applying a plurality of acceleration voltages to cause ions to exit the ion injection device; at each ion energy, measuring the resolving power of the mass analyser with a plurality of sets of electrode voltages applied to the electrodes by varying a first tuning parameter to a respective plurality of values, wherein the first tuning parameter parameterises the electrode voltages applied to the plurality of electrodes; determining maximising values of the first tuning parameter; identifying a point of inflection in the dependence of the maximising values of the first tuning parameter; determining a set of calibrated operating parameters for the massanalyser based on the point of inflection; and causing the mass analyser to operate with the calibrated operating parameters.

### CROSS REFERENCE TO RELATED APPLICATION

This application claims priority to application GB2307711.8, filed May 23, 2023. The entire disclosure of application GB2307711.8 is incorporated herein by reference.

### FIELD

The present disclosure relates to methods for calibrating a time-of-flight (ToF) mass analyser.

### BACKGROUND

Time-of-flight mass spectrometry (TOFMS) is a method of mass spectrometry in which an ion's mass-to-charge ratio (m/z) is determined by a measurement of the time the ion spends in flight. Time-of-flight (ToF) mass spectrometers benefit from relatively high resolving power, the ability to separate and differentiate ions of very close m/z, and to assign that m/z with low ppm level accuracy. Generally, an instrument's resolution is limited by the length of the ion flight path and the quality of the ions time focus at the detector plane. The invention of the ion mirror in 1972 (B. A. Mamyrin, V. I. Karataev, D. V. Shmikk, and V. A. Zagulin, Sov. Phys. JETP, 1973, 37, 45-48.) allowed energy focusing of ions with same m/z but divergent energies, improving the quality of this time-focus and allowing very high resolutions to be achieved.

FIG. 1 shows an example of ion energy focusing in a typical reflectron-ToF analyser. FIG. 1 shows a single reflection ToF mass spectrometer and the ion packet spatial distribution with time. Ions 10 are pulse-ejected from a source, under the influence of an acceleration voltage. The source in this case is an extraction ion trap 13. The ions have a mean energy co and are ejected towards the opening of the ion mirror 11, where they are rapidly decelerated and reflected back down to a detector 12. Hereafter the ion energy is given in terms of the acceleration voltage, i.e., per unit charge. The ion packet, with a large energy spread induced by the pulsed extraction, expands greatly longitudinally in flight, as well as somewhat laterally. Ions with higher energy penetrate further into the mirror 11, and undergo longer flight paths with differing forces, that serve to balance the different flight times with energy and focus ions to a plane at the surface of the detector 12.

Despite initially accelerating with a common voltage difference, the ions possess a certain spread of energies around the mean value ε₀, which usually originates from the spatial spread at the moment of ejection from the trap. The Ion Mirror comprises a number of electrodes with individually defined voltages U₁ . . . . U_{K} chosen to implement the energy isochronism of the reflection, which ensures simultaneous arrival at the detector, independent of the initial ion's energy in a sufficiently wide energy range. As shown in FIG. 1, K=4, but other values of K can be used.

The energy isochronism condition is supposed in multi-reflection ToF analysers, examples of which are given in SU1725289, DE3025764C2, GB2403063, U.S. Pat. No. 9,136,101B2, WO2008/047891 and U.S. Pat. No. 10,964,520B2.

In multi-reflection ToF analysers, the ion trajectory is many times longer due to the folding of the ion path between two opposing mirrors, as shown in FIG. 2. An example of a five-electrode ion mirror is shown in FIG. 2, which is similar to the mirror in U.S. Pat. No. 9,136,101B2. The mirror in FIG. 2 comprises a converging ion mirror 160, two deflectors 170 and 172, a detector 180, an ion trap source 182, an out-of-plane lens 184, and correcting stripe electrodes 190.

It is important to maintain the ion bunch spatial confinement along the whole trajectory, which imposes additional constraints on the optical properties of the ion mirror. For instance, a particular spatial focusing parallel-to-point condition is to be implemented, which may be represented in the form

$${X}_{x} = \frac{\partial {x}_{n + 1}}{\partial {x}_{n}} = 0 \qquad ( 1 )$$

where xₙ₊₁ and xₙ are the ion coordinate perpendicular to the plane of the ion trajectory at the n-th and the (n−1)-th reflections respectively. Another condition is the second-order independence of the reflection time of the ion coordinates

$${T}_{xx} = \frac{{\partial }^{2} {T}_{n}}{\partial {x}_{n}^{2}} = 0 \qquad ( 2 )$$

which is a non-trivial condition for gridless mirrors. The first derivative is guaranteed to be substantially zero for mirror electrodes having a mirror-symmetry with respect to the mid-plane. The extra conditions (1) and (2) may be imposed by an appropriate choice of the mirror electrode voltages Uₖ.

It has been shown by H. Wollnik, A. Casares, D. Radford, and M. Yavor, “Multi-pass time-of-flight mass spectrometers of high resolving power”, Nuclear Instr. and Meth. Phys. Res. A519 (1-2), 373-379 (2004), and Yavor M., Verentchikov A., Hasin J., Kozlov B., Gavrik M, Trufanov A., “Planar multi-reflecting time-of-flight mass analyser with a jig-saw ion path”, Physics Procedia 1 (2008) 391-400, that ion-optical modelling is an effective tool to synthesise the ion mirror geometry and a set of electrode voltages that simultaneously meet the conditions mentioned above.

An example of a five-electrode ion mirror is shown in FIGS. 2 and 3, which is adapted from U.S. Pat. No. 9,136,101B2. FIG. 2 shows an example of a multi-reflection (MR) ToF analyser (MR-ToF) incorporating converging ion mirrors, while FIG. 3 shows the voltage coefficients applied to the mirror system and the simulated energy acceptance. Ions travelling down the drift length are slightly deflected with each pass through the mirrors and additional “stripe” electrodes, which correct for the time-of-flight error created by the varying distance between mirrors. The ions are eventually reflected back down the drift space and focused at a detector. Of the 5 electrodes, one is grounded, one has a strong negative lensing potential U1, and three have potentials U2-4 that retard and reflect the ions. The predetermined optimised potentials are determined by simulation and may be described in terms of coefficients of the ion energy. FIG. 3 shows these coefficients and their application to different electrodes, as well as the proportional time-of-flight error with deviation of energy, showing a ˜6% energy acceptance window at 106 level time accuracy.

A practical implementation requires fine tuning of the electrode voltages in a vicinity of the calculated optimum in order to achieve the best time-of-flight focusing quality. A practical set of voltages may differ from the set of voltages defined by ion-optical modelling due to (a) limited calculation precision, (b) electrode shape inaccuracies, (c) various details left outside the computational model (e.g. fringe effects), and (d) a difference between the requested and actual voltages of the voltage generators.

A real system may not be accurate enough to precisely match simulated behaviour. Precise tuning and calibration of complex ion mirrors is difficult and complex. Results may be gathered by simulation or experiment and mathematical optimisation may be performed, with simulation tending to be more straightforward as the time aberrations may be easily separated and measured. Fine experimental calibration afterwards can be more difficult, with often only a single voltage hand adjusted to align the ToF focal plane to the detector, at some cost to the overall performance. Additionally, the requirement of the voltages' stability comes at the cost of long settling times following a change of the electrode voltages, which makes the tuning procedure time-consuming.

The tuning procedure normally starts from setting the modelled mirror electrode voltages as an initial approximation. Based on the actual experimental performance of the mass-spectrometer, the voltages are then modified in order to maximise resolution and/or transmittance. Finally, an optimal set of mirror voltages is defined, which is normally found within 1% from the modelled optimum. It is difficult, however, to navigate through a multidimensional (four or more) space of voltages to find the optimal set of voltages experimentally. The problem is exacerbated by the fact that every set of voltages should be characterised with a number of measurements, which leads to the whole procedure becoming prohibitively time-consuming.

A method has been shown, whereby the ion kinetic energy was scanned and the energy acceptance repeatedly measured, with the goal of maximising the acceptance. Once this difficult stage was complete, the focal plane position could be optimised either by changing the number of oscillations, or by adjusting an electrode with minimal impact to the reflection properties (Rosenbusch, M., Wada, M., Chen, S., Takamine, A., limura, S., Hou, D., . . . & Wollnik, H. (2021). The new MRTOF spectrograph for nuclear masses following RIBF's ZeroDegree spectrometer, featuring new methodologies for ion selection and mirror optimisation. arXiv preprint arXiv: 2110.11507). A previous paper shows the optimisation of the focal plane alone via a single parameter of the trapping lift potential (Wienholtz, F., Kreim, S., Rosenbusch, M., Schweikhard, L., & Wolf, R. N. (2017). Mass-selective ion ejection from multi-reflection time-of-flight devices via a pulsed in-trap lift. International Journal of Mass Spectrometry, 421, 285-293.).

U.S. Pat. No. 9,396,922B2 describes a complex mirror system with 6 electrodes, with various parameters and restrictions that allow optimisation to achieve high performance.

It is an object of the present disclosure to improve upon known methods for calibrating ToF mass analysers.

### SUMMARY

Against this background, the present disclosure provides a method according to claim 1, a ToF mass analyser according to claim 28, a computer program according to claim 29 and a computer-readable medium according to claim 30.

Embodiments of the present disclosure address problems with calibrating and operating time-of-flight mass spectrometers. The disclosure provides a reproducible and fast mirror calibration routine that may adjust for the small differences in manufactured products without compromising resolution or energy acceptance. The disclosure provides methods for tuning ion mirrors to provide optimal resolution.

The calibration methods can be tailored to specific use cases, such as single ion monitoring (SIM) or Full-MS measurements with varying ion numbers. This can include optimising tuning with regard to balancing space charge influences and detector saturation. Space charge influences can be controlled through the tuning methods described herein, which can help to prevent detector saturation, aiding linear dynamic range and quantitation.

Accordingly, the disclosure provides a method for calibrating a time-of-flight (ToF) mass analyser comprising an ion injection device and an ion mirror comprising a plurality of electrodes. The method comprises applying a plurality of acceleration voltages to cause ions to exit the ion injection device to provide to the mass analyser ions having a respective plurality of ion energies (referred to herein as ε).

The method further comprises: at each ion energy, measuring the resolving power of the mass analyser with a plurality of sets of electrode voltages applied to the electrodes by varying a first tuning parameter (referred to herein as _{T}1) to a respective plurality of values. This allows the resolution of the mass analyser to be determined at a plurality of different values in the ε-_{T}1 space. Each measurement of the resolution for a given pair of values of ion energy ε and first tuning parameter _{T}1 may be obtained by analysing a different packet of ions. The ions may be a calibrant having a known m/z.

The first tuning parameter parameterises the electrode voltages applied to the plurality of electrodes. For example, the first tuning parameter may be a scalar value that, when changed, causes the voltages on the electrodes to vary in a particular direction in the multidimensional voltage space U₁ . . . . U_{K}. The parameterisation may be a non-trivial parameterisation. For example, the parameterisation of the electrode voltages may be chosen such that varying the first tuning parameter causes a change in a certain time-of-flight aberration in the mass analyser while not causing a change in at least one further aberration in the mass analyser. For instance, varying the first tuning parameter may substantially (e.g. to first order) not cause a change in at least one further aberration in the mass analyser. Thus, with an appropriate parameterisation, it may be possible to fine-tune the voltages on a mass analyser to reduce the influence of a particular aberration without inadvertently introducing other unwanted aberrations (which would be introduced when changing the potential on just a single electrode by an arbitrary amount).

The methods of the present disclosure further comprise determining, for each of the plurality of ion energies, maximising values of the first tuning parameter at which the resolving power is maximised. That is, for each particular ion energy, the value of the first tuning parameter with the highest resolution may be identified and recorded. This leads to the identification of a plurality of values of the first tuning parameter that maximise the resolution for a given ion energy. This plurality of values of the first tuning parameter is described herein as “maximising values of the first tuning parameter”. Each value of the first tuning parameter in the set of maximising values corresponds to a certain ion energy. Thus, a table of maximising pairs {ϵₖ, T1ₖ} (with index k numerating the points) may be obtained.

The methods further comprises identifying a point of inflection (i.e. a point at which the second derivative is zero) in the dependence of the maximising values of the first tuning parameter on the ion energies. The maximising values of the first tuning parameter and the associated ion energies define a function that relates the maximising values of the first tuning parameter τ1 to values of the ion energy E. A point of inflection in this function can be used to advantageous effect. For example, a point of inflection in this relationship may be indicative of substantially optimal tuning of the mirror. Accordingly, the method the method further comprises determining a set of calibrated operating parameters for the mass analyser based on the point of inflection, the set of calibrated operating parameters comprising a calibrated set of electrode voltages (i.e. the voltages applied to each of the electrodes after calibration).

Finally, the method further comprises: causing the mass analyser to operate with the calibrated operating parameters. This can provide an efficient and effective method for calibrating a ToF mass analyser.

As mentioned previously, varying the first tuning parameter leads to a change in the set of electrode voltages. The voltages on each electrode may be varied by different amounts depending on the parameterisation chosen. Adjusting the first tuning parameter by an arbitrary amount may cause the voltages U₁ . . . . U_{K} to change by different amounts. Accordingly, in some embodiments, the electrode voltages applied to the electrodes are independently adjustable. Each electrode may be held at a different voltage to each other electrode. The voltage applied to each electrode may be varied independently of the voltages applied to each other electrode.

The point of inflection may be a point at which the dependence of the optimal first tuning parameter (_{T}1) vs. the acceleration voltages _{T}1 (ε) has a change in sign in its curvature (e.g. where _{T}1′(ε)=0). Thus, the point of inflection may be a specific point in the ε-_{T}1 plane where the first- and the third-order TOF aberration coefficients vanish: T′ (ε)=0 and T′″(ε)=0, where T represents the time-of-flight. In some embodiments, the curve _{T}1 (ε) may also parametrically depend on the second tuning parameter _{T}2, such that _{T}1 can be expressed as _{T}1 (ε, _{T}12). Then the methods may comprise determining a value of the second parameter _{T}2 that causes the second-order ToF aberration coefficient to vanish, i.e. T″ (ε)=0 in the inflection point (at a specific _{T}2). This may be a simple one-dimensional optimization problem. As a result, all three orders of ToF aberration can be caused to vanish together and we a third-order ToF focus may be achieved. Known calibration methods often look at T vs. ε to locate a first-order focus, in which T′ (ε)=0, but some embodiments of the present disclosure provide methods for providing third-order focusing that can cause T′(ε), T″(ε), and T″(ε) to vanish simultaneously.

The routines of some embodiments provide an efficient and effective way of performing calibration, through the use of parametrised perturbations about a predetermined optimal point (as determined by, for example, simulation, or by analysis of one or more measurements performed on the mass analyser and/or one or more measurements performed on mass analysers of the same type) to adjust different properties, such as the first and/or second derivatives of time vs energy. The fitting of energy acceptance curves to resolution heatmaps also provides an efficient way of identifying calibrated operating parameters, as does interpolating optimum operating parameters from two curves.

In some embodiments, the use of a carefully controlled ion number during calibration can prevent tuning to high space charge effects.

In some embodiments, finer calibrations can be performed, with additional scans of _{T}1 for fine adjustments to desired use cases. In some embodiments, mass-to-charge ratio correction (or recalibration) can be performed, for example when space charge effects are known to be probable. In some embodiments, the degree of space charge may be deliberately tuned (e.g. by controlling ion number and/or by adjustment of tuning parameters) to prevent detector saturation.

Some embodiments transform phase space between the ion injection device and the ion mirror in at least two dimensions. Conventional ToF reflectrons may only do this in one direction, i.e. in the direction of ToF dispersion, while MR-ToFs do this in all 3 dimensions but usually inside the mirror system. Some embodiments rotate the plane of temporal focusing between the ion injection device and the ion mirror, or between the ion mirror and the detector.

These and other advantages will become from the following disclosure.

### Listing of Figures

The present disclosure will now be described by way of example, with reference to the accompanying figures, in which:

FIG. 1 shows a conventional reflectron-ToF analyser;

FIG. 2 shows the ion trajectory in a multi-reflection ToF analyser;

FIG. 3 shows the structure and voltage coefficients of a mirror system of a multi-reflection ToF analyser;

FIGS. 4A-4D show the relationship between peak shape, resolution and ion number;

FIGS. 5A-5C show how a point of inflection can be used to determine calibrated operating parameters;

FIGS. 6A-6B show simulated time-of-flight vs. ion energy data;

FIGS. 7A-7B show experimental heatmaps of resolution vs. ε and τ₁;

FIG. 8 shows a hybrid mass spectrometer that can be calibrated using the methods described herein;

FIGS. 9A-9B show methods of determining calibrated operating parameters according to some embodiments;

FIGS. 10A-10C show energy acceptance curves (trap offset adjustment vs _{T}1 resolution plot) for differing _{T}2 values;

FIGS. 11A-11D show full MS Flexmix™ mass spectra;

FIGS. 12A-12D show the effect of varying _{T}1 on MRFA peak resolution and m/z position;

FIGS. 13A-13B show a comparison between SIM and full-MS MRFA space charge influence;

FIGS. 14A-14F show the same full Flexmix™ scans as FIGS. 12A-12D, during Full-MS scans of ion accumulation time at varying _{T}1 values;

FIG. 15 shows a mirror calibration incorporating a shifted _{T}1 parameter for optimisation of behaviour that changes with some characteristic of the desired analytes; and

FIG. 16 shows the relationship between ion trap well depth on tolerance to high space charge of isolated MRFA ions.

### DETAILED DESCRIPTION

### General Overview

The present disclosure is concerned with a method of calibrating the voltages applied to the electrodes of an ion mirror of a ToF mass analyser, such as a multi-reflection ToF analyser. These ion mirrors may comprise five electrodes, where a first electrode is grounded, and the other four have high voltages U1-U4 applied to them. Other numbers of electrodes would be possible.

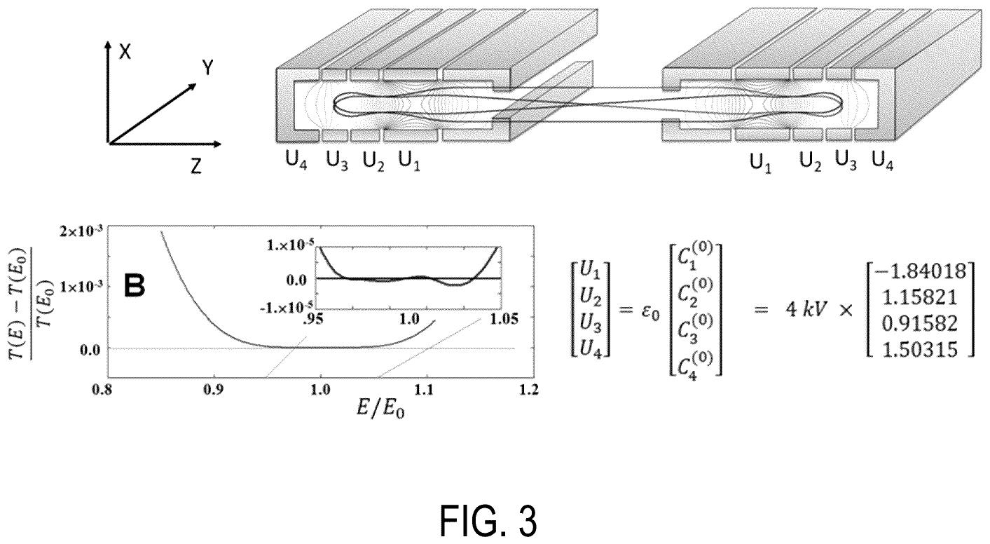

The design of the electrodes and the voltages U={U₁ . . . . U₄} may be determined in simulation so that the oscillation time, T, of ions between the mirrors, is substantially independent of ion injection energy ε across some range ε0±Δε/2, where ε0 is the mean energy given to a packet of ions as they are ejected from an ion trap (or other ion injection device) into the ToF mirrors. As described with reference to FIG. 3, a simulated optimised set of voltages Ū⁽⁰⁾ can be calculated that provides an energy acceptance window Δε/ε0=6%.

However, in practice, due to manufacturing imperfections etc., these four voltages should be tuned in the vicinity of the calculated values Ū⁽⁰⁾ to achieve a suitable energy acceptance window. A conventional approach to doing this would involve exploration of the 4-dimensional voltage space in the vicinity of Ū⁽⁰⁾, which is a complex and time-consuming task. Furthermore, given that the mirror electrode voltages should preferably be highly stable, the required settling time between each voltage change is relatively long, so such a procedure is prohibitively time consuming.

Some embodiments of the present disclosure adopt an approach in which four new orthogonal vectors are defined in the U1-U4 voltage space, with each vector corresponding to one of the four most significant aberration coefficients: T_{ε}⁽¹⁾ (the first derivative of time-of-flight with respect to ion energy); T_{ε}⁽²⁾ (the second derivative of time-of-flight with respect to ion energy); xₓ (as in equation (1)); and Tₓₓ (as in equation (2)). This basis has the benefit that, in practice, tuning of xx and Tₓₓ can be omitted because may already be guaranteed by design of the mirrors to be reasonably accurate, thereby reducing the dimensionality of the required tuning by two. Embodiments of the disclosure therefore involve tuning one (or two) parameters, _{T}1 and _{T}2, with each of these parameters being the respective magnitudes of the vectors that point in the T_{ε}⁽¹⁾ and T_{ε}⁽²⁾ directions. Embodiments of the present disclosure recognise that by tuning one or more of the parameters _{T}1 and _{T}2, an efficient, reliable and accurate calibration routine can be provided.

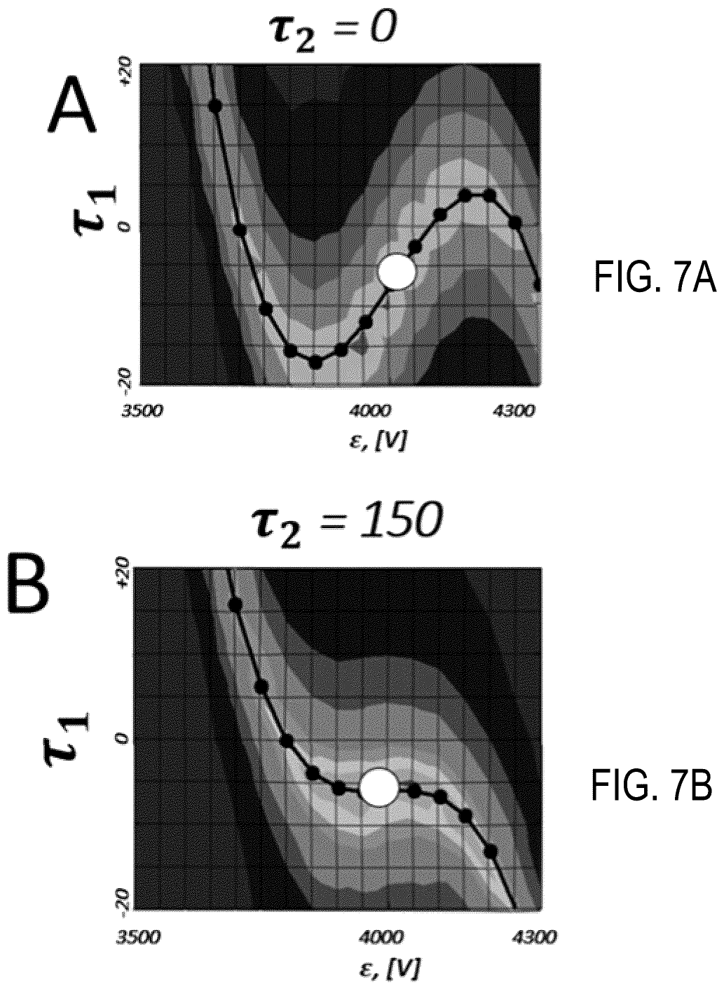

In some embodiments, this is performed by firstly setting _{T}2=0, and sweeping _{T}1 across a range centred at the predetermined optimum value, at each of a number of energy ε values, and measuring the resolution of the ToF at each point (steps 2 and 3 of the Worked Example). This gives data as shown in FIG. 7A, from which a curve of the maximum resolution can be obtained (the solid black line in the heat map). From this curve, an optimised value of _{T}2 can be estimated (steps 4 and 5 of the Worked Example). This step can be done using one _{T}1 vs ε sweep with _{T}2=0, but may optionally done by interpolating between two such sweeps at different values of _{T}2. As shown in FIG. 7A, a confirmation sweep may optionally be performed (step 6 of the Worked Example) using the estimated optimised value of _{T}2.

Each measurement in the calibration routine may be performed with a small enough number of ions to avoid space charge effects. However, optionally, _{T}1 may be subsequently tuned to provide better resilience of the analyser's resolution to space charge for larger ion packets.

### Space Charge Effects

Space charge effects in ion-trap ToF analysers, such as those described above, impose severe limitations on performance. In common orthogonal ToF analysers, where ions are extracted into the analyser at 5-30 KHz with poor transmission, space charge influences are not widely observed.

The impact of large ion numbers on detector saturation is well known. Space charge effects caused by electron-electron repulsion within an electron multiplication stage produce not only non-linear signal output but also m/z shifts with increasing intensity, as noted in, for example, U.S. Pat. No. 8,581,183B2. Even where the detector has a wide range of voltage output (for example the multiple volts produced by some modern electron multipliers or diode-based detectors), the recording of that signal may then be hindered by the bit depth of analog to digital conversion.

In ToF analysers fed by accumulating ion traps (or other ion injection devices), hundreds of thousands of charges may be injected simultaneously into the analyser, generating very strong space charge effects. These are exacerbated in multi-reflection systems, which use lenses to keep the ion beam tightly focused. Grinfeld showed the very strong impact of space charge in such tightly focused systems, causing self-bunching and coalescence of adjacent m/z peaks (Grinfeld, D., Giannakopulos, A. E., Kopaev, I., Makarov, A., Monastyrskiy, M., & Skoblin, M. (2014). Space-charge effects in an electrostatic multireflection ion trap. European Journal of Mass Spectrometry, 20 (2), 131-142). In particular, this demonstrated how “hardening” of the mirror potentials could be used to compensate somewhat for space charge effects, an effect that has also been demonstrated for Orbitrap analysers. Kozlov rationalised loss of resolution observed for intense ions as a consequence of ion packet's focal plane shifting out of alignment with the detector plane, and like Grinfeld, noted the value of stronger mirror voltages to compensate (B. Kozlov, S. Kirillov and A. Monahov, Analysis of Coulomb interaction effects in high resolution TOF and electrostatic FT mass spectrometers in terms of phase space rotation, Am. Soc. Mass. Spectrom. Conf. 2012).

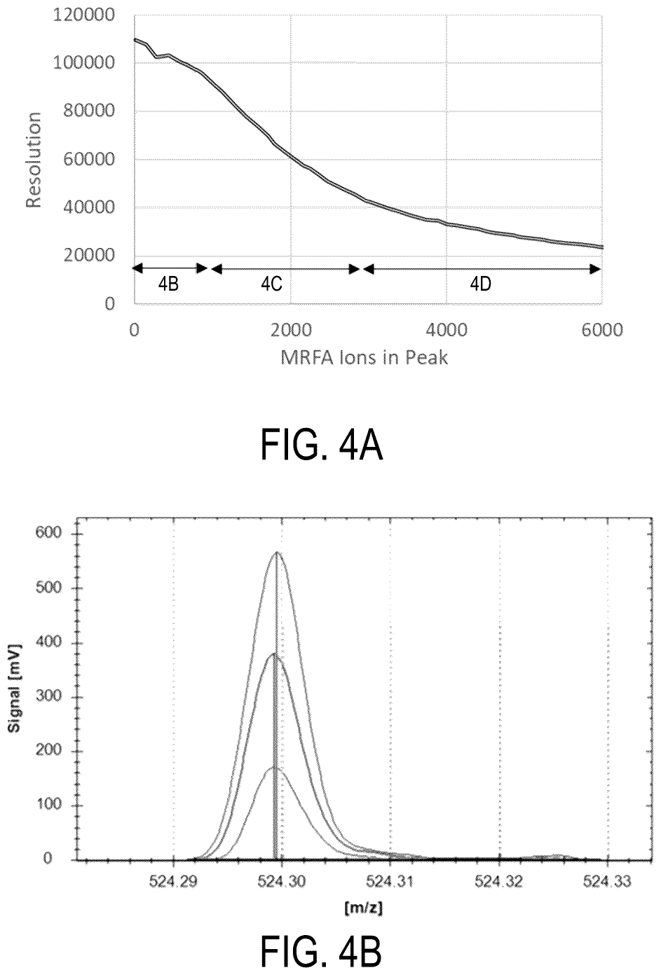

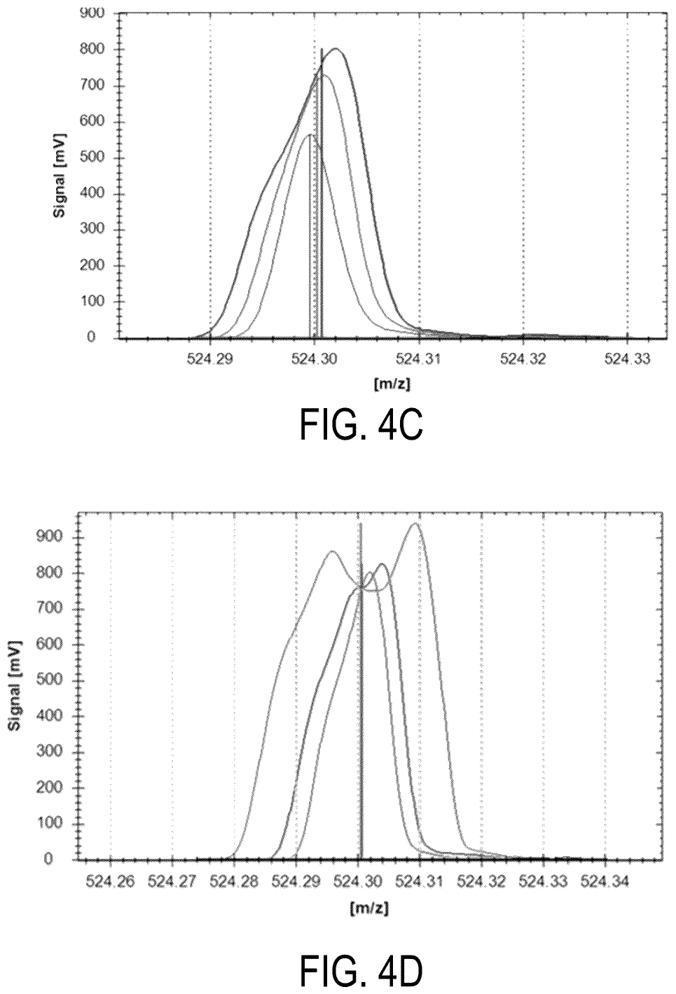

One advantage of the converging mirror analyser of FIG. 2 is that it allows the ion beam to expand in the drift dimension, reducing the charge density considerably. However, space charge effects are still notable as being very strong in practice. GB2612574 showed loss of resolution and mass accuracy with increasing ion numbers, both as single m/z packets in the time-of-flight analyser, and due to the expansion of the trapped ion cloud as a function of total number of ions across all m/z, plus the properties of the trap itself. FIGS. 4A-4D show this loss of resolution with ion number and the widening, shifting peak shape, with the peak shapes duplicated from GB2612574.

### Detector Saturation

Ion detectors are generally limited in their maximum current output, both on timescales of individual peaks and over longer acquisition periods. Space charge repulsion within electron multipliers, as one example, causes gain to fall for higher intensity peaks, limiting dynamic range. From a minimum signal, ˜5-10 mV, required to reliably detect single ions, detecting a thousand in a narrow peak would require a 5-10V maximum linear output. This is beyond typical electron multipliers, which gives 1-3V, whilst linear detection of 10,000 ions in-peak would be beyond any fast detector. There are many ways to improve the linear range of a detector. For example, most conventionally a pre-amplifier may be used, though this comes with cost of increased noise. Peaks may be recorded at different gain stages, and a lower gain output channel used for intense peaks as described in U.S. Pat. No. 8,680,481B2. Detector gain may be adjusted in anticipation of large peaks, either based on ion signal measurement (automatic gain control), or even nanosecond fast response to sampling of the peak as in U.S. Pat. No. 9,214,322B2. There may also be multiple detectors, with the ion beam split between them so that one detector output is far more attenuated than the other.

The reduction of peak resolution caused by ion-ion coulomb repulsion/space charge, spreads the ion arrivals out in time, reducing the instantaneous burden on the detector as a beneficial side-effect. For intense peaks, mass accuracy may be maintained even with much lower resolution, as the ion number is high enough to make up for damage to statistical accuracy.

### Calibration

The ions' time of flight (for a specific m/z) is representable as a Taylor series

$$T ( ε , \overline{U} ) ≅ {T}_{0} + {\sum }_{n = 1 …} \frac{1}{n !} {T}_{ε}^{( n )} ( \overline{U} ) Δ {ε}^{n} , Δ ε = ε - {ε}_{0} \qquad ( 3 )$$

where ε is the ion's initial energy, Ū={U₁ . . . . U₄} is the set of all mirror electrode voltages, and T_{ε}⁽ⁿ⁾ are the n-th order derivatives with respect to energy, calculated at ε=ε₀.

By design of a third-order focusing spectrometer, the first non-compensable coefficient is T_{ε}⁽⁴⁾ while the coefficient T_{ε}⁽³⁾ is small. The coefficients T_{ε}⁽¹⁾ and T_{ε}⁽²⁾ are also small by design. However, the practical implementation of spectrometers requires tuning by appropriate choice of the voltages U to make these coefficients vanish.

The choice of the mirror voltages is not arbitrary, however. The mirror's operating mode should ideally also provide the first-order focusing condition (1) and the second-order ToF-spatial aberration correction (2). Thus, the dimensionality of the space of acceptable mirror voltages is reduced by two. In order to scan the set of voltages in the vicinity of the modelled point Ū⁽⁰⁾, the voltage space may be factorised according to the modelled gradients of the most essential aberrational coefficients:

$$[ \begin{matrix}{T}_{ε}^{( 1 )} \\ {T}_{ε}^{( 2 )} \\ {x}_{x} \\ {T}_{xx}\end{matrix} ] = M \times [ \begin{matrix}{U}_{1} - {U}_{1}^{( 0 )} \\ {U}_{2} - {U}_{2}^{( 0 )} \\ {U}_{3} - {U}_{3}^{( 0 )} \\ {U}_{4} - {U}_{4}^{( 0 )}\end{matrix} ] + … , M = ( \begin{matrix}\frac{{\partial }^{2} T}{\partial ε \partial {U}_{1}} \\ \frac{{\partial }^{3} T}{\partial {ε}^{2} \partial {U}_{1}} \\ \frac{{\partial }^{2} x}{\partial {x}_{0} \partial {U}_{1}} \\ \frac{{\partial }^{3} T}{\partial {x}_{0}^{2} \partial {U}_{1}}\end{matrix} … \begin{matrix}\frac{{\partial }^{2} T}{\partial ε \partial {U}_{4}} \\ \frac{{\partial }^{3} T}{\partial {ε}^{2} \partial {U}_{4}} \\ \frac{{\partial }^{2} x}{\partial {x}_{0} \partial {U}_{4}} \\ \frac{{\partial }^{3} T}{\partial {x}_{0}^{2} \partial {U}_{4}}\end{matrix} ) \qquad ( 4 )$$

where the matrix of gradients M is calculated with an appropriate software for ion-optical simulations. Inversion of the dependence (4) gives the factorisation of the mirror electrode voltages with only two parameters τ₁ and ₂

$${U}_{k} = {U}_{k}^{( 0 )} + Δ {U}_{k}^{( 1 )} \times {τ}_{1} + Δ {U}_{k}^{( 2 )} \times {τ}_{2} \qquad ( 5 )$$

using the first two columns ΔUₖ⁽¹⁾ and ΔUₖ²) of the pre-calculated inverse matrix M⁻¹. With this specific choice of possible directions of mirror voltage variations in the voltage space, a modification of the parameter τ₁ results in a shift of T_{ε}⁽¹⁾ by a specified amount while the value of the coefficient T_{ε}⁽²⁾ stays unchanged. On the other hand, the coefficient τ₂ modifies T_{ε}⁽²⁾ while substantially conserving T_{ε}⁽¹⁾.

The factorisation (5) guarantees that scanning the voltages in a sufficiently small vicinity of the modelled values Uₖ⁽⁰⁾ does not drive the coefficients xₓ and Tₓₓ substantially away from their small values, because the vector of the voltage deviation is orthogonal to the gradients of these coefficients.

While these statements are only perfectly fulfilled in simulation, it has been found that they still provide a valid approximation for a real ion-optical system and therefore provide an improved calibration routine.

Returning to the generalised terms used previously, varying the first tuning parameter preferably causes a change in a time-of-flight aberration (e.g. T_{ε}⁽¹⁾) in the mass analyser. For example, the first tuning parameter may correspond to the vector ΔUₖ⁽¹⁾. Hence, varying the first tuning parameter causes a change in a first-order time-of-flight aberration in the mass analyser while substantially not causing a change in at least one further aberration in the mass analyser. The at least one further aberration may comprise any one or more of: second-order time-of-flight aberrations with respect to ion energy (e.g. T_{ε}⁽²⁾); second-order time-of-flight aberrations with respect to ion coordinates (equation (2)); and parallel-to-point spatial focusing of ions (equation (1)). Depending on the choice of the parametrisation, other aberrations can be left unchanged when varying the first tuning parameter.

The methods described herein may further comprise measuring the resolving power of the mass analyser at a plurality of values of a second tuning parameter that parameterises the electrode voltages applied to the plurality of electrodes. Measuring the resolving power of the mass analyser at the plurality of values of the second tuning parameter may be performed for each of the plurality of ion energies and for each of the plurality of sets of electrode voltages. Varying the second tuning parameter may cause a change in a second-order time-of-flight aberration in the mass analyser (e.g. T_{ε}⁽²⁾). Varying the second tuning parameter may cause a change in a time-of-flight aberration in the mass analyser while substantially not causing a change in at least one other aberration in the mass analyser. The at least one other aberration in the mass analyser may comprise any one or more of: first-order time-of-flight aberrations with respect to ion energy; second order time-of-flight aberrations with respect to ion coordinates; and parallel-to-point spatial focusing of ions. Depending on the choice of the parametrisation, other aberrations can be left unchanged when varying the second tuning parameter.

The first tuning parameter and/or the second tuning parameter may correspond to a parameterisation of the electrode voltages based on aberrations (e.g. ToF aberrations) in the mass analyser. The aberrations may comprise any one or more of: first-order time-of-flight aberrations with respect to ion energy; second-order time-of-flight aberrations with respect to ion energy; second-order time-of-flight aberrations with respect to ion coordinates; and parallel-to-point spatial focusing of ions. By factoring the voltage space in terms of these aberrations, fine control over the aberrations can be obtained.

The parameterisation may be a linear parameterisation, but non-linear parametrisations are also feasible. The parameterisation may be based on a series expansion (e.g. a Taylor expansion) of the aberrations in the mass analyser. In a sufficiently small area around the optimal operating parameters, variations in appropriate directions give rise to substantially linear changes in behaviour of the system, which facilities effective calibration. Preferably, the parameterisation expresses the electrode voltages in terms of: predetermined (e.g. simulated) optimal values of the set of electrode voltages; the first tuning parameter; and a vector in the space of electrode voltages corresponding to the first tuning parameter; and preferably a second tuning parameter and a vector in the space of electrode voltages corresponding to the second tuning parameter.

The proposed parameterisation (5) offers the following benefits:
1. The dimensionality of the parametric tuning space is reduced to only two because the special focusing property xₓ and the second-order derivative of the time-of-flight with respect to the out-of-plane coordinate Tₓₓ usually do not need to be tuned in practice and are already guaranteed by design to a reasonable approximation.
2. Each tuning parameter only affects one particular focusing property (aberration) of the mirror system, which can be evaluated after a change of this parameter. In contrast, all four properties would require re-evaluation after changing a single electrode voltage.

Equation (3) may be differentiated with respect to the ion energy to obtain:

$${T}_{ε}^{′} ( ε , U ) ≅ {T}_{ε}^{( 1 )} + {T}_{ε}^{( 2 )} Δ ε + \frac{1}{2} {T}_{ε}^{( 3 )} Δ {ε}^{2} + \frac{1}{6} {T}_{ε}^{( 4 )} Δ {ε}^{3} \qquad ( 3 a )$$

with a fixed set of voltages Ū. Equation (5), however, introduces the voltages as functions of two parameters. Equation (6) considers the time-of-flight as functions of energy, τ₁, and τ₂, in which the parameterised voltages are substituted into equation (3a). By noting that the parameterisation is defined such that τ₁ causes a change in substantially only T_{ε}⁽¹⁾ and τ₂ causes a change in substantially only T_{ε}⁽²⁾, equation (6) can be derived:

$${T}_{ε}^{′} ( ε , {τ}_{1} , {τ}_{2} ) ≅ ( {T}_{ε}^{( 1 )} + {τ}_{1} ) + ( {T}_{ε}^{( 2 )} + {τ}_{2} ) Δ ε + \frac{1}{2} {T}_{ε}^{( 3 )} Δ {ε}^{2} + \frac{1}{6} {T}_{ε}^{( 4 )} Δ {ε}^{3} \qquad ( 6 )$$

$$where Δε = ε - {ε}_{0} .$$

It should be noted that τ₁ substantially does not affect T_{ε}⁽²⁾ and τ₂ substantially does not affect T_{ε}⁽¹⁾ by definition of the parameterisation (5) through the specific choice of the vectors ΔUₖ^{(1,2)}. However, both coefficients may alter the higher-order derivatives of the time-of-flight. Therefore, the approximate equality in equation (6) should be understood up to the precision of Δε. Equation 6 is not exactly a Taylor series up to the third order, but terms like τ₁Δε² and τ₂Δε² are omitted. This is justifiable because the parameters τ₁ and τ₂ are small.

The first order ToF focusing condition is achieved when the derivative of the time of flight with respect to the ion energy provided in equation (6) vanishes.

In order to tune the system into a high-order focusing mode, the parameter τ₁=τ₁^{(m)}(Δε) may be determined as a function of the deviation of the ions' energy Δε from the designed value co by scanning the acceleration voltage in a range Δε=±0.1 ε₀ (although other values, such as ±0.2 ε₀ could also be used) In practical examples, this may involve scanning from approximately 3700V to approximately 4100V, but various other voltages may be used depending on the specific mirror arrangement.

The full-width half maximum (fwhm) spread of ToF ΔT is determined and the resolution map is calculated as R(ε, τ₁)=T/2ΔT. For each fixed value of the energy deviation Δε, an optimal parameter τ₁ that delivers a maximum resolution may be introduced. This optimal parameter is a function of mean ion energy defined as τ₁^{R} (ε)=argmax (ε, τ₁). The points {ε, τ₁^{R} (ε)} lie on a curve on the Δε, τ₁ space where at least the first-order ToF focusing T′_{ε}=0 is attained. This procedure determines maximising values of the first tuning parameter _{T}1 at which the resolving power is maximised, for each of the plurality of ion energies. Some embodiments instead use the point of inflection from a fitting procedure rather than the point of maximum resolution.

The experimentally derived function τ₁^{(R)}(ε) may be further compared with the model function that is derived from equation (4) and the first-order focusing condition T′_{ε}=0. According to the Taylor series in equation (6), the model curve τ₁^{R} (Δε) is, in this approximation, a cubic function

$${τ}_{1}^{R} ( ε ) ≅ - {T}_{ε}^{( 1 )} - ( {T}_{ε}^{( 2 )} + {τ}_{2} ) Δε - \frac{1}{2} {T}_{ε}^{( 3 )} Δ {ε}^{2} - \frac{1}{6} {T}_{ε}^{( 4 )} Δ {ε}^{3} \qquad ( 7 )$$

in which the actual values of the aberrations T_{ε}⁽ⁿ⁾ are unknown. Smallness of the coefficient T_{ε}⁽³⁾ according to the design of the mirror system means that the curve has a point of inflection in the considered range of ion energies. The value τ₁^{R} optimizes the resolution at a fixed ion energy. As the ions have an intrinsic energy spread, a necessary condition for the resolution maximum is T′_{ε}(ε, τ₁, τ₂)=0. By equating equation (6) to zero, equation (7) can be obtained.

The next step of the tuning procedure is to locate the inflection point of the function τ₁^{R} (ε) in which the second derivative vanishes. The inflection point (ε*, τ*₁) is a candidate for the tuned working parameters of the ion mirrors.

The first derivative dτ₁^{R}/dε is not necessarily zero at the identified inflection point. However, as formula (7) suggests, the setting the parameters τ₂ adds a linear term—τ₂Δε to the function τ₁^{R} (ε) which may compensate the slope at the inflection point. From this, an optimal value of the second tuning parameter τ*₂ can be approximated.

$${τ}_{2}^{*} ( {ε}^{*} ) = \frac{d {τ}_{1}^{R}}{d ε} ( {ε}^{*} - {ε}_{0} ) \qquad ( 7 a )$$

It should be noted that formula (7) and, therefore, formula (7a) are approximate and show only a qualitative behaviour of the curve τ₁^{R} (ε). Therefore, it may be more accurate to fit the region of the ε, τ₁ plain with the highest resolution with a polynomial function, e.g. a cubic function

$${τ}_{1}^{R} ( ε ) = a + b Δ ε + c Δ {ε}^{2} + d Δ {ε}^{3} , Δ ε = ε - {ε}_{0}$$

and then to define the inflection point as ε*=ε₀−c/3d and the slope at this point as

$$slope ( {τ}_{2} ) = {τ}_{1}^{{R}^{′}} = b + 2 c Δ {ε}^{*} + 3 d Δ {ε}^{* 2} = b - \frac{{c}^{2}}{3 d} \qquad ( 8 )$$

This fitting operation can be performed with a number of values of the parameter τ₂ resulting in a functional dependence of the slope in the inflection point on the parameter τ₂. This dependence is close to linear. The optimised value at which slope (τ*₂)=0 may therefore found by interpolation of this dependence between two (or more than two) measured values of τ₂.

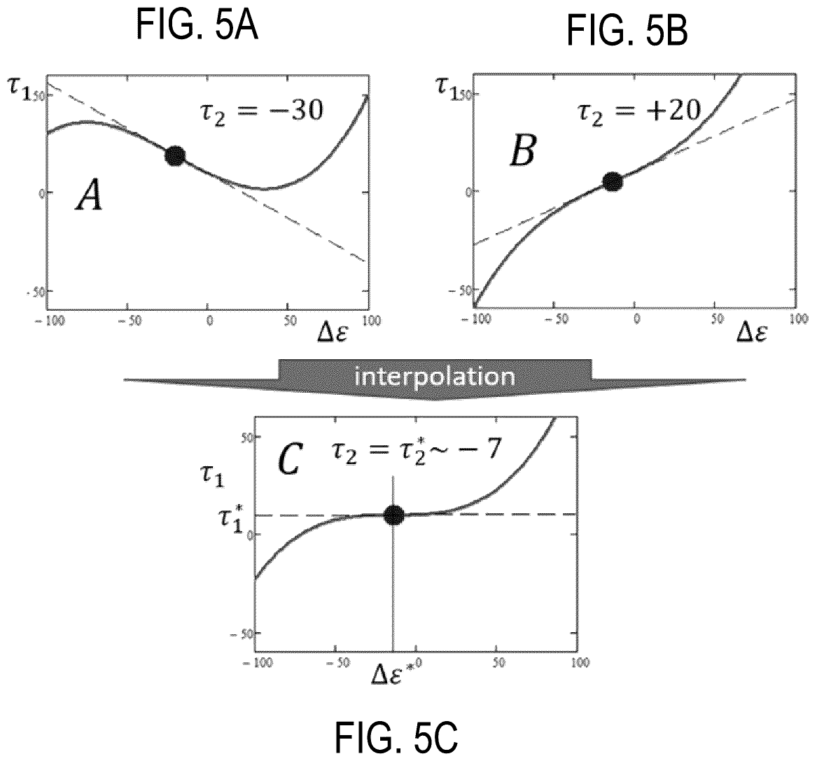

FIGS. 5A-5C show an illustration of the method. Three curves τ₁^{(R)} (ε) are the sets of points where T′_{ε}=0 that correspond to the first-order time-of-flight focus. FIGS. 5A and 5B illustrate the situation when τ₂ is below and above the optimal value respectively. FIGS. 5A and 5B differ by the sign of the slope at the points of inflection (shown with circles). Some embodiments comprise finding the value of τ*₂ for which the slope (i.e. the derivative of the maximising values of the first tuning parameter with respect to ion energy) at the point of inflection is exactly (or substantially) zero. The outcome of the procedure is a triple (ε, τ₁, τ₂) that define the mode of exact third-order ToF focusing.

In doing so, a true third-order ToF focusing is realised for a specific value of the ion energy ε* with a specific set of voltages:

$${U}_{k}^{*} = {U}_{k}^{( 0 )} + Δ {U}_{k}^{( e 1 )} \cdot {τ}_{1}^{*} + Δ {U}_{k}^{( e 2 )} \cdot {τ}_{2}^{*} \qquad ( 9 )$$

Equation (9) may define the calibrated operating parameters of the mass analyser.

A final optional step may involve re-scaling all mirror voltages in the proportion

$${U}_{k}^{( tuned )} = \frac{{ε}_{0}}{{ε}^{*}} {U}_{k}^{*} \qquad ( 10 )$$

which brings the tuned ToF focus to a desired value of the average ion energy co. This step of re-scaling may be omitted entirely because E″ will often be close to co.

Returning to the generalised terms used previously, in embodiments of the disclosure, determining the set of calibrated operating parameters may comprise determining an optimal value of the second tuning parameter at which the maximising values of the first tuning parameter have a first derivative of zero (or substantially zero) with respect to the plurality of ion energies at the point of inflection. That is, through control of the second tuning parameter, the inflection point can be forced to be a stationary point where both the first and second derivatives of the maximising values of the first tuning parameter with respect to ion energy are zero. This can ensure optimal tuning of the first and second tuning parameters. The ion energy may be treated as an independent variable in this routine.

Determining the optimal value of the second tuning parameter may be based on the derivative of the maximising values of the first tuning parameter with respect to ion energy at the point of inflection. The optimal value can be calculated analytically or by performing repeated measurements. For instance, determining the optimal value of the second tuning parameter may comprise: determining the derivative of the maximising first tuning parameter with respect to ion energy at the point of inflection; determining the derivative at a plurality of values of the second tuning parameter; and determining the optimal value of the second tuning parameter based on interpolating the derivative at the plurality of values of the second tuning parameter. Two, three or more values of the second tuning parameter can be used. Since the functional dependence of the slope in the inflection point on the parameter τ2 is close to linear, a relatively accurate calibration can be performed based on interpolation from just two values of the second tuning parameter.

### Worked Example

The foregoing method has been implemented for tuning a system of the type shown in FIGS. 2 and 3. Ion optical modelling gives the following values for the coefficients in the matrix M as follows:

| | ∂/∂U₁ | ∂/∂U₂ | ∂/∂U₃ | ∂/∂U₄ |
|---|---|---|---|---|
| T_{ε}⁽¹⁾/T | 1.08E−05 | 8.50E−05 | 1.57E−04 | −1.48E−04 |
| T_{ε}⁽²⁾/T | −8.24E−05 | −2.95E−04 | 3.13E−04 | −7.22E−05 |
| Xₓ | −5.62E−04 | 1.01E−03 | −4.55E−05 | −1.44E−03 |
| Tₓₓ/T | 4.32E−04 | −1.85E−03 | −3.69E−03 | 2.73E−03 |

The inverse matrix can be computed as:

where the first two columns determine the parametric subspace (τ₁, τ₂). For convenience, in this embodiment, the vectors ΔUₖ⁽¹⁾ and ΔUₖ⁽²⁾ are normalised by the coefficient 0.0025 (this may be an arbitrary value and this re-scaling may be omitted entirely).

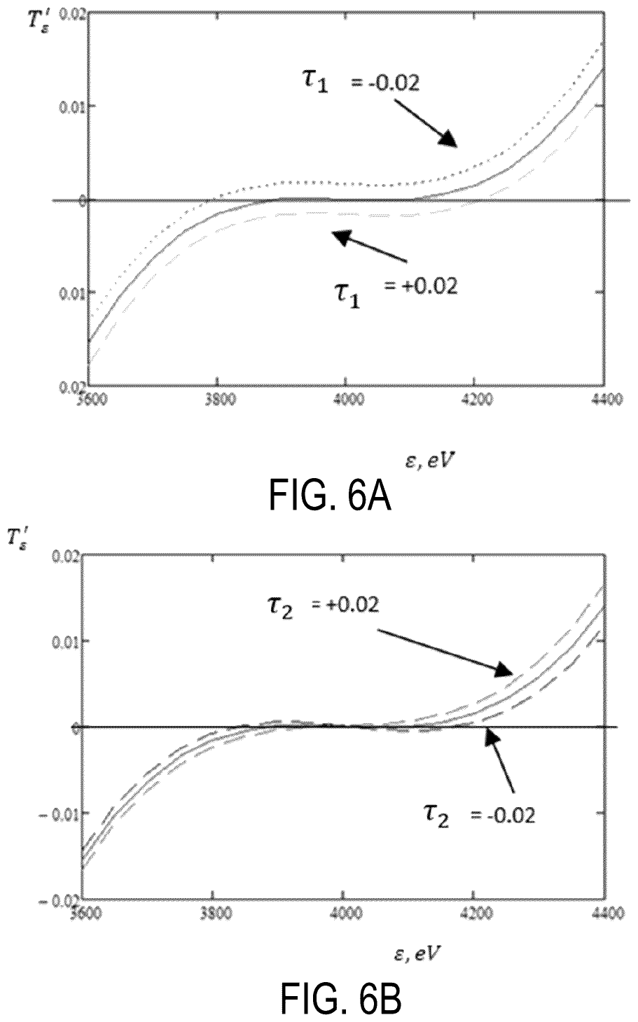

The simulated time-of-flight vs. ion energy is shown in FIGS. 6A-6B. FIGS. 6A-6B demonstrate the influence on ion time-of-flight deviation with energy, of different values of τ₁ and τ₂.

In the computational model, the working conditions ε=ε₀=4000 eV and the unperturbed mirror voltages (τ₁=τ₂=0) provide the ideal third-order ToF focusing. It can be demonstrated in simulations that the τ₁ parameter implements a shift of the derivative T′_{ε} and the parameter τ₂ entails a linear tilt of the graph T′_{ε}(ε).

Manufactured systems show, however, somewhat different focusing conditions. Experimental heatmaps of resolution vs. ε and τ₁ are shown in FIGS. 7A-7B. The resolution heatmaps are plotted against the mean ion injection energy and the tuning parameter τ₁. The fitted curve in a dark solid line shows the maximum of resolution with a fixed ion energy. FIG. 7A shows the data obtained before a τ₂ correction is applied. The inflection point of this curve is found and circled. FIG. 7B shows the heatmap after an appropriate τ₂ correction is applied, such that the inflection point has a first derivative of zero (i.e. has zero inclination, or is flat).

The maximum resolution curve τ₁^{R} (ε)=argmax (ε, τ₁) is a curvy function of ion energy with an easily measurable inflection point at Δε*=4040 eV, τ₁=−6, as shown in FIG. 7A. In order to rectify the tilt of the maximum resolution curve, the parameter τ₂ may be set to the value τ*₂=150, as shown in FIG. 7B. This provides a calibrated mirror.

Finally, the mirror voltages may be multiplied by the factor

$$\frac{{ε}_{0}}{{ε}_{0} + Δ {ε}^{*}} = \frac{4000 eV}{4040 eV} = 0.99$$

in order to relocate the focus to the intended acceleration energy of 4000 eV.

The above-noted full tuning procedure may be summarised as follows:
1. Set approximate mirror voltages simulated from an ion-optical model
2. Vary the acceleration voltage of the ion source in order to scan the mean ion injection energy
3. For each value of the mean ion injection energy, scan the parameter τ₁
4. Locate the point of inflection ε* of the curve τ₁^{R} (ε) and find the inclination (the first derivative) of this curve at the point of inflection
5. Adjust the parameter τ₂ in order to make this inclination zero. As a result, both the first and the second derivatives of τ₁^{R} (ε) vanish at the point of inflection
6. (Optional) measure τ₁^{R} (ε) with the updated τ₂. In case of insufficiently accurate tuning, repeat steps 4 and 5
7. (Optional) Scale the mirror voltages proportionally by the factor ε₀/ε* in order to shift the focus to the designed mean injection energy ε₀.

In a general sense, in the methods described herein, applying a plurality of acceleration voltages and/or a plurality of sets of electrode voltages may comprise: varying the ion energies about a predetermined or simulated optimal value of the ion energy (e.g. ε₀); and/or varying the first tuning parameter about a predetermined or simulated optimal value of the first tuning parameter (e.g. 0) that corresponds to predetermined or simulated optimal values of the set of electrode voltages. A second or further tuning parameters may also be varied about predetermined or simulated optimal value(s). Due to the factorisation used in some embodiments, the predetermined or simulated optimal value of the first and/or second tuning parameter may be 0. The methods of the present disclosure provide a quick and reliable method for tuning an ion mirror in the vicinity of a pre-determined optimal configuration, which can be determined by ion-optical simulation.

The methods can provide a set of calibrated operating parameters comprising a calibrated acceleration voltage corresponding to the ion energy at the point of inflection. The calibrated acceleration voltage may be the voltage required to provide ions having the ion energy of the point of inflection. The calibrated ion energy may be ε* or may be rescaled by some value. The set of calibrated operating parameters may comprise a calibrated acceleration voltage and the method may further comprise scaling the calibrated set of electrode voltages such that the calibrated acceleration voltage has a pre-determined value (e.g. ¿ 0). For example, it may be desirable for the analyser to operate at 4 kV acceleration voltage, but the optimization may gave a point of inflection at 3.9 kV. Then, the mirror voltages and the acceleration voltage may be scaled by the factor 4/3.9 to make the acceleration voltage exactly the desired value.

The calibrated set of electrode voltages is preferably based on the predetermined optimal values of the electrode voltages varied by the maximising value of the first tuning parameter corresponding to the point of inflection, and preferably varied by a maximising value of a second tuning parameter corresponding to the point of inflection. For example, as shown in equation 9, the calibrated set of electrode voltages can be represented as a sum of uₓ⁽⁰⁾ and two voltage perturbations that are controlled by the values of the first and second tuning parameters:

$$Δ {U}_{k}^{( e 1 )} \cdot {τ}_{1}^{*} + Δ {U}_{k}^{( e 2 )} \cdot {τ}_{2}^{*} .$$

Once values of the tuning parameters have been optimised under regular space charge conditions, additional optimisations of τ₁ only may be performed for different space charge conditions. It has been observed that τ₁ is particularly suitable for controlling space charge effects. For example, the number of ions in peaks may be adjusted to vary space charge effects, or the spatial distribution of ions at the point of injection into the analyser may be varied. Suitable values of τ₁ may be determined to balance resolution and space charge, or resolution and whether the detector may become saturated within the desired m/z range, etc. Hence, the methods described herein may be performed for a plurality of peaks containing different numbers of ions (i.e. with different space charge conditions), the method further comprising: determining a plurality of measures of signal quality for the mass analyser using the plurality of peaks; determining a relationship between the measures of signal quality and the numbers of ions; and determining the value of the first tuning parameter for the calibrated operating parameters based on the relationship between the measure of signal quality and the number of ions.

It should be noted that while steps 1-7 illustrate a full calibration procedure, benefits can arise from varying τ₁ and τ₂ independently. For example, the two tuning parameters each provide the ability to adjust voltages without affecting particular aberrations within an ion mirror. Therefore, if an existing system already provides adequate tuning of the τ₂ parameter (for example due to its design, or due to having previously been tuned to an optima value of τ₂), then step 5 may be omitted. Therefore, advantages can be obtained from adjusting only the τ₁ tuning parameter.

### Experimental Implementation

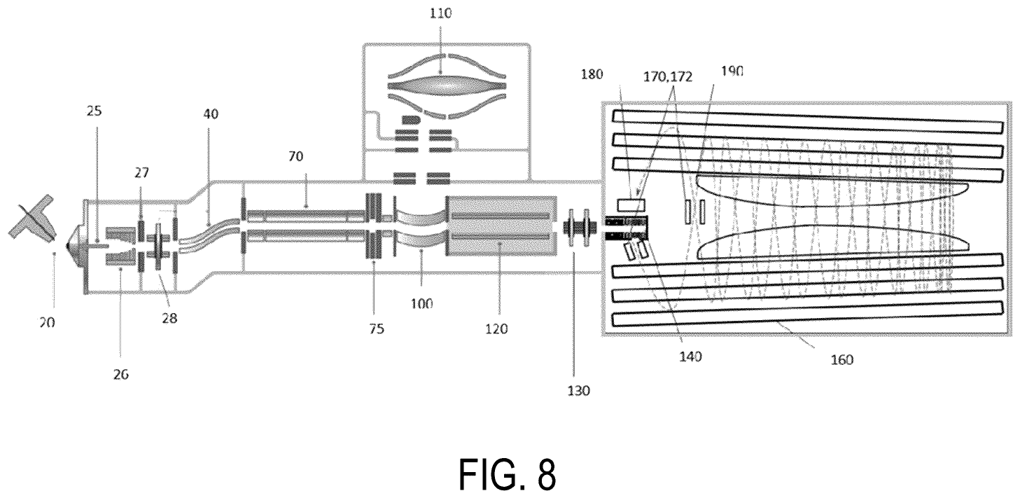

The calibration routine was developed for a hybrid mass spectrometer incorporating a quadrupole mass filter paired to an orbital trapping (e.g. Orbitrap™) and MR-ToF mass analysers. This is shown in FIG. 8 and is of the form described by Giannakopulos in U.S. Pat. No. 10,699,888B2, and utilises the MR-ToF analyser of U.S. Pat. No. 9,136,101B2. FIG. 8 is a hybrid mass spectrometer incorporating a quadrupole filter coupled to orbital trapping and time-of-flight analysers.

Ions generated by an electrospray ion source 20 traverse the vacuum interface, incorporating a transfer capillary 25, an ion funnel 26, a quadrupole pre-filter 28 and a bent quadrupolar ion guide (bent flatapole) 40, before being mass selected by a quadrupole 70 and delivered through to the ion routing multipole 120 for cooling. Ions may then either be passed back to the C-Trap 100 for pulsed extraction into the orbital trapping mass analyser 110, or sent further into a high-pressure region of the MR-ToF's extraction trap 140 and optionally fragmented, before being delivered to the low pressure extraction region of the trap and pulse-extracted into the MR-ToF analyser.

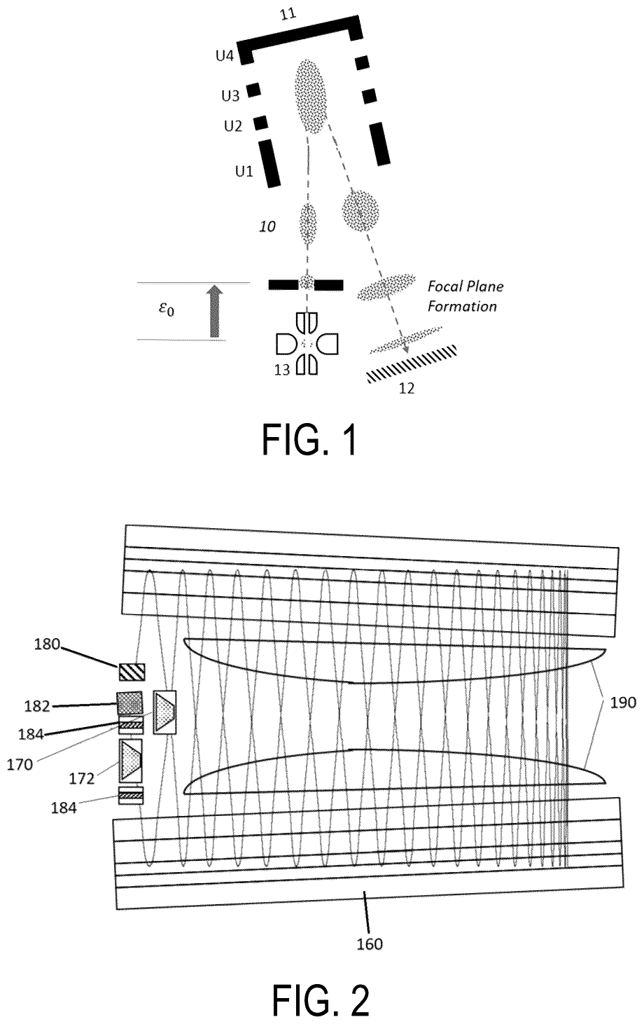

A number of elements of FIG. 8 are configured similarly to the systems described in U.S. Pat. No. 10,699,888B2 and illustrated in FIG. 1 thereof. Therefore, U.S. Pat. No. 10,699,888B2 is incorporated herein by reference and the same reference numerals are described for elements common to U.S. Pat. No. 10,699,888B2 and the present disclosure. In particular, the functioning of each of the following elements is described more fully in U.S. Pat. No. 10,699,888B2: electrospray ionisation source 20; capillary 25; injection flatapole 40; quadrupole filter 70; C-trap 100; orbital trapping mass analyser 110; fragmentation chamber 120; extraction trap 140; opposing tilted ion mirrors 160; deflectors 170, 172; detector 180; and correcting stripe electrode 190.

It should be noted that the quadrupole filter 70 allows delivery of a limited mass range, and an ion gate built into the charge detector allows fine control of accumulation time, controlling the number of ions admitted. Measurement of single ion detector response allows understanding and control of the number of ions in any peak of infused calibrant sample.

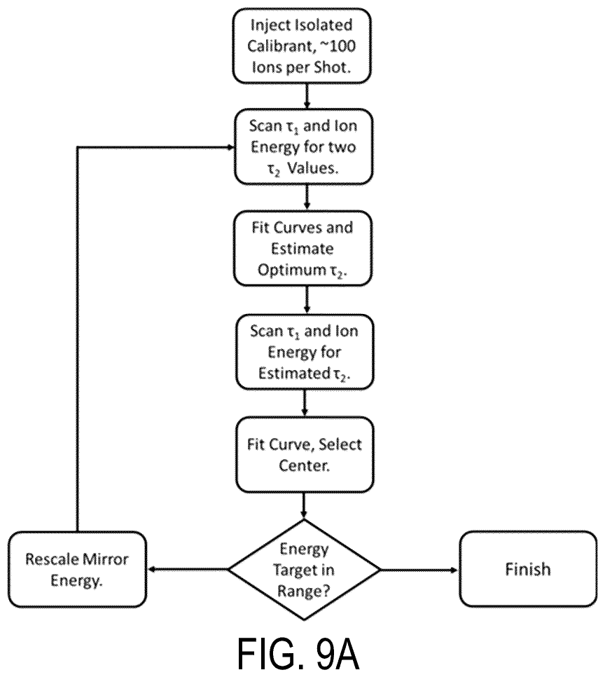

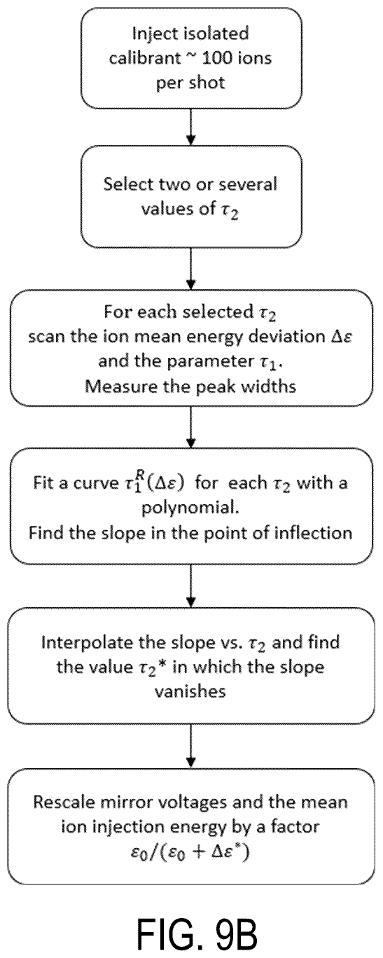

FIG. 9A shows a suitable flowchart for the basic optimisation of mirror parameters _{T}1 and _{T}2, from starting values. In experiments, suitable calibrant ions, such as MRFA⁺, generated from infused Pierce™ Flexmix™ calibration solution, were isolated using a quadrupole and a relatively small load of ˜100 ions injected per shot. This low load may be important as isolated ions may suffer stronger in-peak space charge effects than when many different m/z ions are mixed in the trap, and it can be advantageous to avoid over-hardening the calibration. It is possible to perform full calibration with a full mass range of mixed calibrant instead, and ion numbers representative of real analytes, but it may be more difficult to track the target peak (or peaks if several are to be monitored and average values determined).

The next step is that _{T}1 and the trap offset, which sets the ion energy, are scanned for two _{T}2 values (which are preferably very different from each other), in this case with 12=+/−50. Because _{T}1 shifts the focal plane, the resolution optima will shift across _{T}1 values the more the ion time-of-flight deviates with the energy shift. This means that a heatmap of resolution for these 2D scans will produce a similar picture to the energy acceptance curves of FIGS. 6A-6B, and several such examples are shown in FIGS. 7A-7B. The _{T}1 resolution optima for every ion energy value is detected and consequent curves fitted.

In generalised terms, the methods described herein comprise applying a plurality of acceleration voltages to cause ions to exit an ion injection device to provide to a mass analyser ions having a respective plurality of ion energies (ε). At each ion energy, the methods comprise measuring the resolving power of the mass analyser with a plurality of sets of electrode voltages applied to the electrodes by varying a first tuning parameter (τ₁) to a respective plurality of values. The first tuning parameter parameterises the electrode voltages applied to the plurality of electrode (for instance as shown in equation (9)). The methods further comprise determining maximising values of the first tuning parameter for each of the plurality of ion energies at which the resolving power is maximised. The result of this procedure can be shown as the heatmap in FIGS. 7A-7B, with the curve of maximal resolution also shown.

The resolution vs. two parameters is normally known as a map R (ε, τ₁). A robust algorithm to construct a fitting polynomial function τ₁^{R} to such data is follows: The unknown function is parameterised as τ₁^{R} (ε₀+Δε)=a+bΔε+cΔε²+dΔε³ with the unknown coefficients a, b,c,d. The following penalty function is constructed

$$penalty ( a , b , c , d ) = {\int }_{{τ}_{1 , min}}^{{τ}_{1 , max}} {\int }_{{ε}_{min}}^{{ε}_{max}} {{[ \frac{R ( ε , {τ}_{1} )}{\overline{R} ( ε )} ]}^{α} [ {τ}_{1}^{R} ( ε ; a , b , c , d ) - {τ}_{1} ]}^{2} d ε d {τ}_{1}$$

where integration is done over the region of the resolution map. In doing so, the discrepancy of τ₁^{R}−τ₁ is measured with the weight proportional to the resolution to the power of a>0. Therefore, the minimum of the penalty is reached if the difference |τ₁^{R}−τ₁| is smallest at those pairs Δε, τ₁ for which the resolution is maximal. The τ₁-average of the resolution is R̅(Δε)=∫_{τ}_{_{1,min}}^{τ}^{_{1,max}} R (Δε, τ₁)dτ₁. The best value of the parameter a has been found to be a=3. The penalty function defined in this way is a quadratic function of the unknown parameters a, b, c and d, which allows easy evaluation of these parameters without resorting to an iterative procedure.

One implementation of such a fit is to calculate a weighted average of all measured values τ₁⁽ⁱ⁾ as

$${\overline{τ}}_{1}^{( j )} = \frac{{\sum }_{i} {τ}_{1}^{( i )} {R ( {τ}_{1}^{( i )} , {ε}^{( j )} )}^{k}}{{\sum }_{i} {R ( {τ}_{1}^{( i )} , {ε}^{( j )} )}^{k}}$$

for all measured values ε^{(j)} and then minimise the sum of squares of the deviations Σⱼ(ƒ(ε^{(j)})−τ₁^{(j)})² between this center-of-mass value and the model function ƒ(ε). Here the exponent of the resolution k to calculate this weighted average (or center-of-mass) value is a hyper-parameter that can be tuned and is usually set to 3. This sum-of-squares can be rewritten as a usual sum of squares over all measured resolutions R(τ₁⁽ⁱ⁾,ε^{(j)}) as follows

$${\sum }_{j} {( f ( {ε}^{( j )} ) - {\overline{τ}}_{1}^{( j )} )}^{2} = {\sum }_{i , j} {( \frac{( f ( {ε}^{( j )} ) - {τ}_{1}^{( i )} ) R {( {τ}_{1}^{( i )} , {ε}^{( j )} )}^{k}}{{\sum }_{i} {R ( {τ}_{1}^{( i )} , {ε}^{( j )} )}^{k}} )}^{2}$$

and thus the usual toolboxes for linear regression can be used to fit the cubic function. Measurement of the curve parameters allows calculation of a _{T}2 value (as well as _{T}1 and energy offset) that maximises the energy acceptance. An additional scan at this _{T}2 value may provide confirmation of this, as well as final measurement of appropriate _{T}1 and ion energy settings.

Thus, returning to the generalised terms used previously, the methods described herein further comprise identifying a point of inflection (e.g., a point at which the second derivative is zero) in the dependence of the maximising values of the first tuning parameter on the ion energies; and determining a set of calibrated operating parameters (e.g. based on the tuned values (ε, τ*₁, τ*₂)) for the mass analyser based on the point of inflection.

A final optional check in FIG. 9A, particularly when the ion energy range is restricted by power supply limitations, is that if the energy target is out of range, then the calibration may be repeated with the mirror parameters rescaled to a lower or higher energy, for example 3900 eV instead of 4000 eV.

FIG. 9B shows a further example of a calibration routine. In FIG. 9B, isolated calibrant may be injected. For example, approximately 100 ions per shot may be injected. Then, the mirror may be set to two or more different values of the second tuning parameter _{T}2. At each value of the second tuning parameter _{T}2, the ion energy and the first tuning parameter _{T}1 may be scanned across respective ranges, and one or more peaks may be obtained. The widths of the peaks may be determined. A curve may be fit for each value of the second tuning parameter _{T}2, and the slope at the point of inflection for each value of the second tuning parameter _{T}2 is identified. Then, the slope can be interpolated to find a calibrated value of the second tuning parameter _{T}2. Finally, mirror voltages may be rescaled, as in step 7 described above.

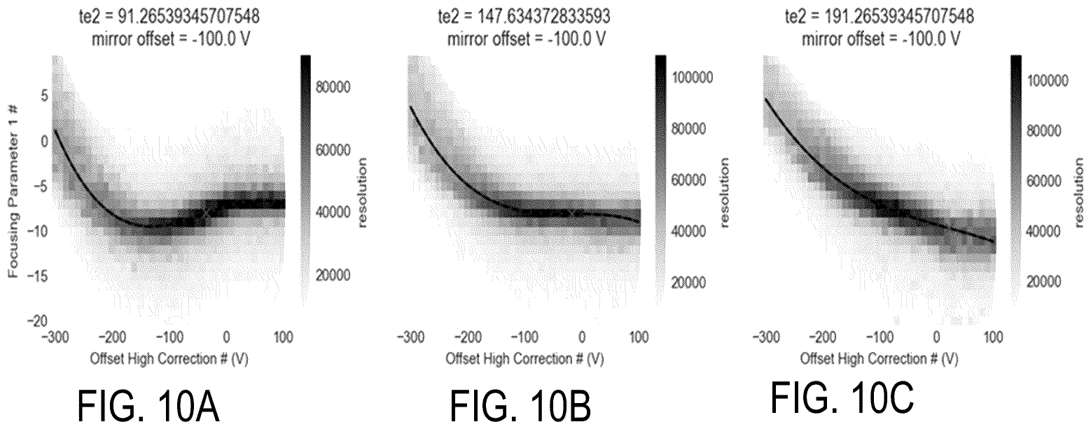

FIG. 10 shows experimental data showing the energy acceptance curves (trap offset adjustment vs _{T}1 resolution plot) for differing _{T}2 values. To obtain the data in FIG. 10, the mirror potentials were pre-adjusted for −100V ion energy.

### Space Charge/Detector Saturation Adaptation

Space charge effects often cause issues in time-of-flight mass spectrometry, hampering resolution as in-peak ion number and consequent space charge increases. In-trap space charge expands the ion cloud, widening the energy spread of ions, and reducing ToF resolution as a consequence, but also decreasing the charge density of extracted ion packets and generally reducing in-peak space charge effects.

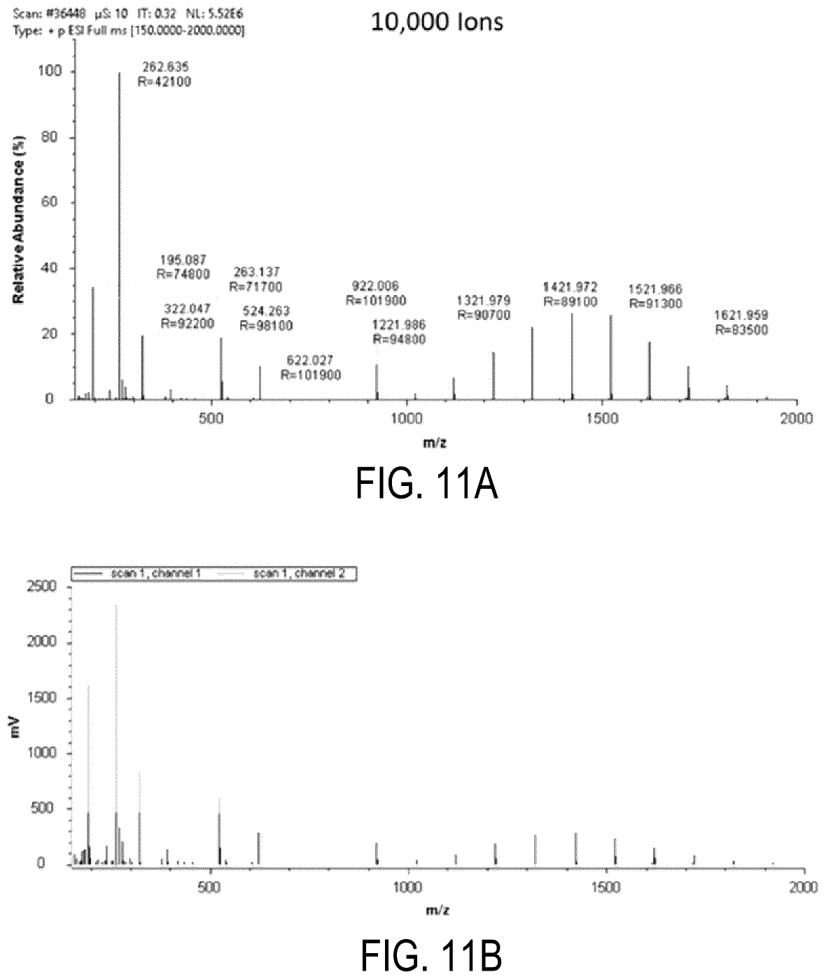

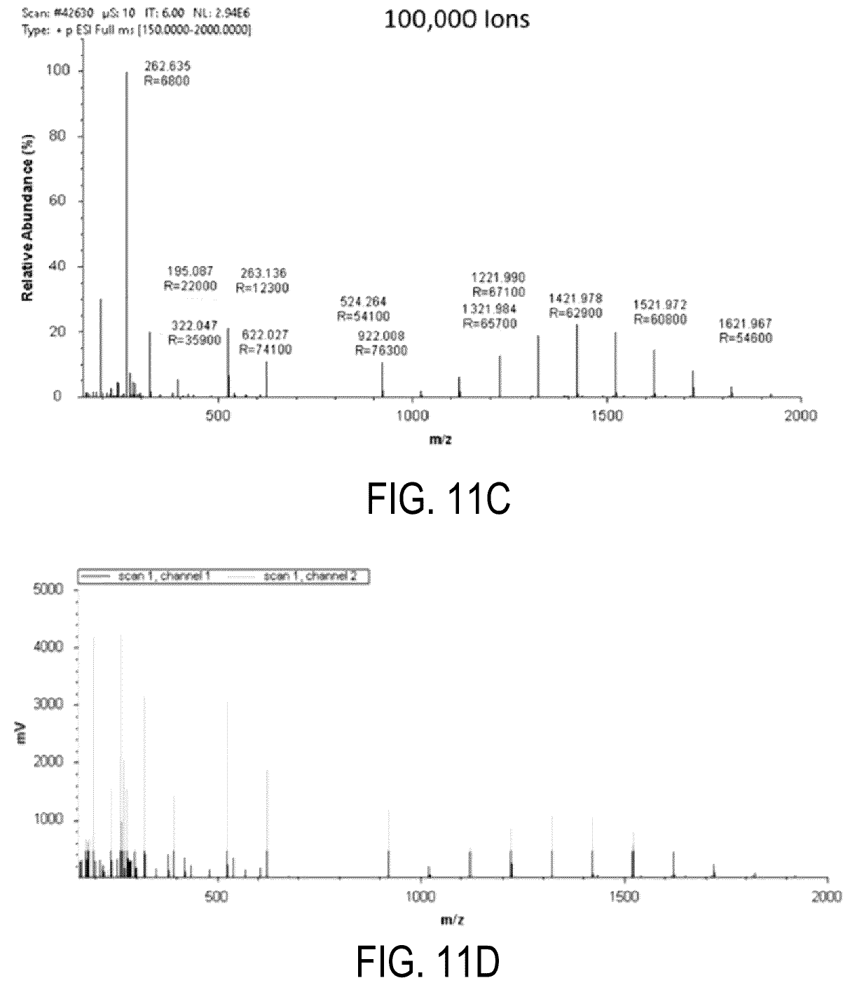

FIGS. 11A-11D show full MS Flexmix™ mass spectra at differing ion accumulation times. ToF intensity and profile mass spectra are shown of 10,000 and 100,000 detected ions of Pierce™ Flexmix™ calibration solution, showing loss of resolution and lack of detector saturation (5V level) due to space charge effects.

It can be seen that resolution is much lower in the latter case, particularly for the low m/z peaks, which are both intense and occupy a smaller volume (high pseudopotential well depth) in the RF extraction trap. Also shown are profile peaks for both different gain channels of a 2-channel detector. The second channel would become saturated at just below the 5V input level, but this level was never quite reached for even the highly intense m/z 262 peak. The resolution loss caused by space charge protects the detector from saturation effects.

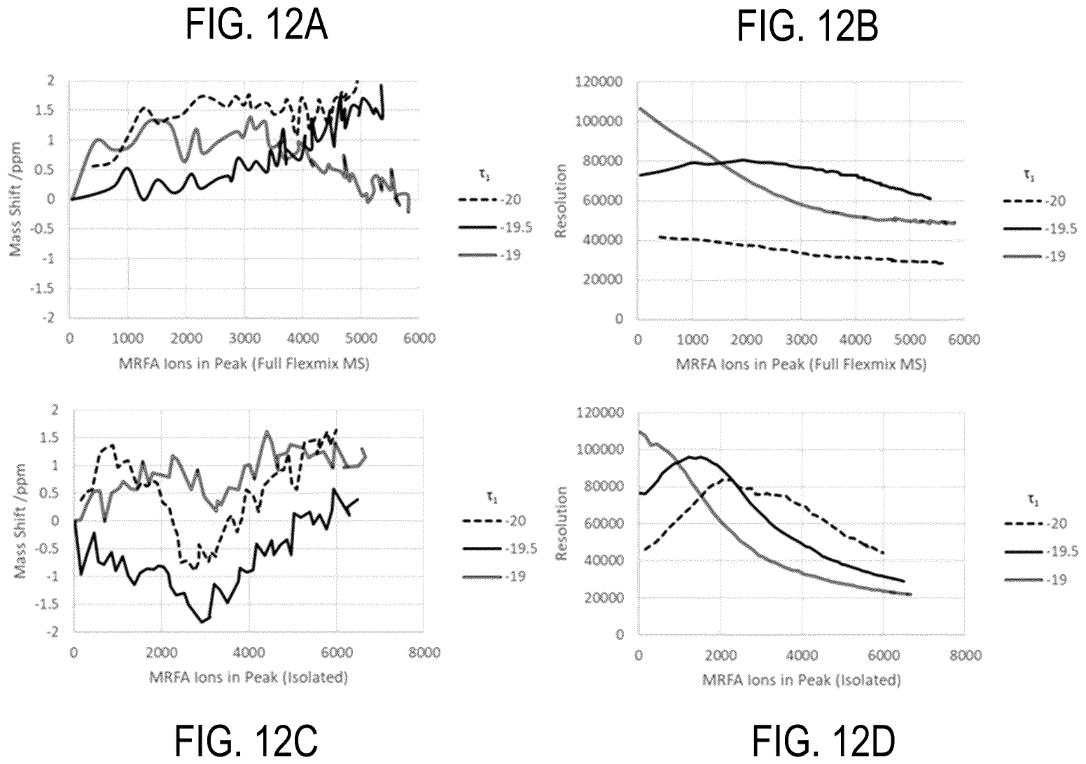

The _{T}1 parameter can advantageously be used for controlling space charge effects. This can be performed by modifying _{T}1 in isolation, or also with adjustment to average ion energy. FIGS. 12A-12D shows space charge dependent resolution and mass shift behaviour for MRFA ions with differing _{T}1 settings, either quadrupole isolated or with wide range injection of mixed calibrant ions. FIGS. 12A-12D show the impact of varying _{T}1 on MRFA peak resolution and m/z position as the number of ions was changed, both in isolation and with the full range of Flexmix™ calibrant ions. In the latter case, the ion number in-trap increased greatly, to almost 150K ions detected, and this in-trap space charge caused in-peak resolution to drop off less quickly than when MRFA was isolated.

The highest low ion number resolution was observed at roughly the same _{T}1 value, as might be expected, but because of the more rapid drop off it may be more appropriate to adjust the _{T}1 value by −0.5 for monitoring of single isolated ions (SIM).

The mass drifts observed are smaller than in GB2612574, and are on the order of ˜1.5 ppm. Without wishing to be bound by theory, the reason for this may relate to improved mirror tuning, or reductions in mirror fringe field interactions made in the intervening time. The m/z drift data does not provide a compelling reason to adjust _{T}1.

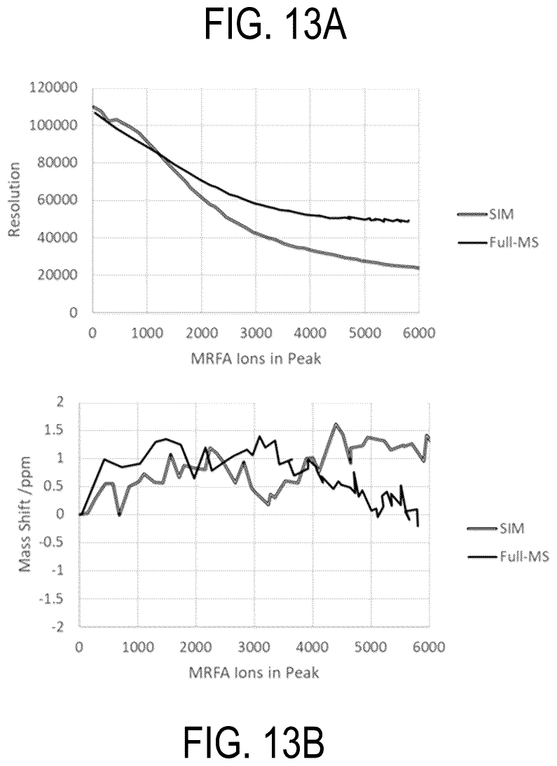

FIGS. 13A-13B shows a direct comparison between SIM and full-MS MRFA space charge influences, and emphasises the increased loss of resolution in SIM mode. The comparison of MRFA space charge dependencies in SIM and Full MS of Flexmix™ ions was performed at _{T}1=−19.

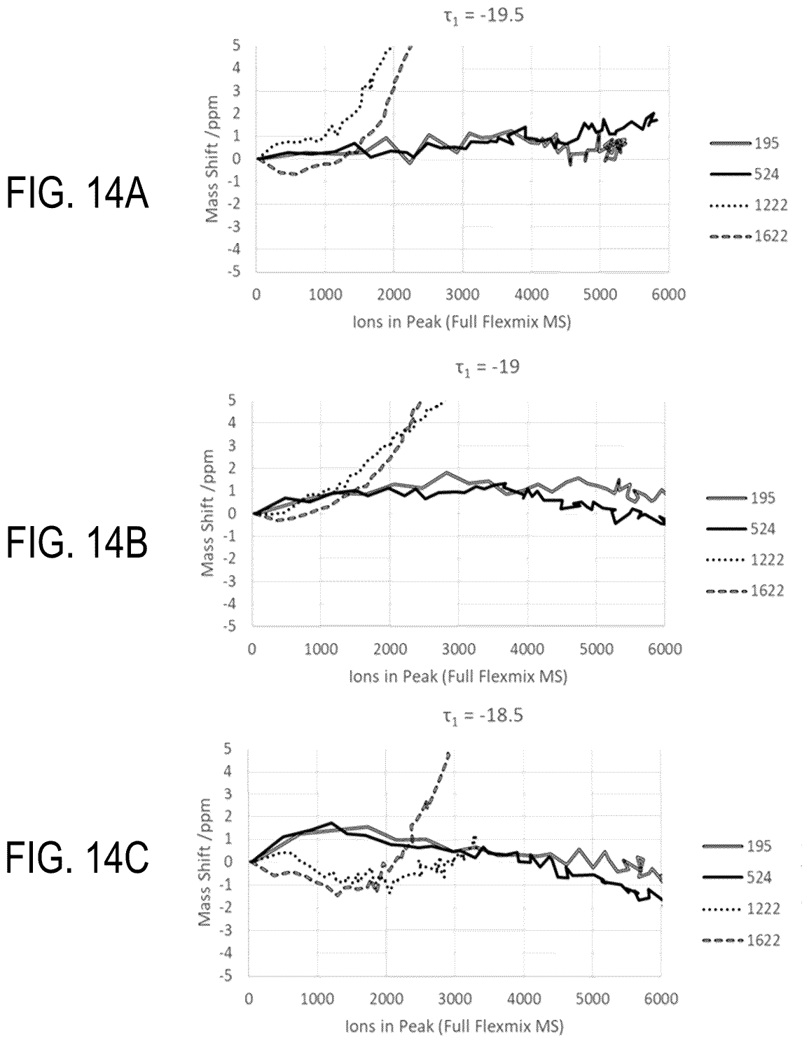

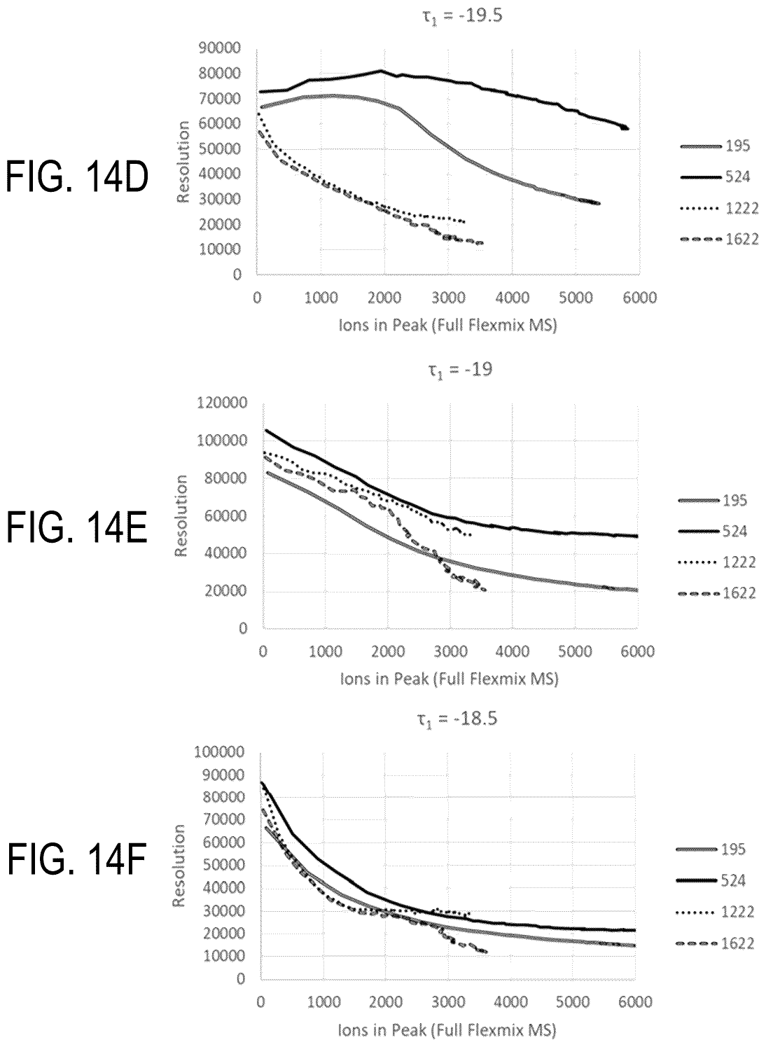

FIGS. 14A-14F show the same full Flexmix™ scans of FIGS. 12A-12D, during Full-MS scans of ion accumulation time at varying _{T}1 values, but tracking multiple ions of varying m/z. The caffeine ion at m/z 195 behaves almost similarly to MRFA, albeit with lower initial resolution and markedly stronger resolution losses. The larger ultramark ions at m/z 1222 and 1622 are notably not stabilised by a harder _{T}1 value such as −19.5, and at high ion loads suffer a runaway shift in m/z measurement position. Such effects were also seen in GB2612574, when very high (˜100K+) overall ion numbers cause severe in-trap space charge effects which push out the highest m/z ions to the fringes, as these are the least well RF trapped. Such effects do not appear to be completely independent of _{T}1 value, as m/z 1222 is spared the onset when _{T}1=−18.5, however the influence on low m/z resolution at this level is limited. It can be deduced that generally _{T}1=−19 remains the optimum for this analyte mixture.

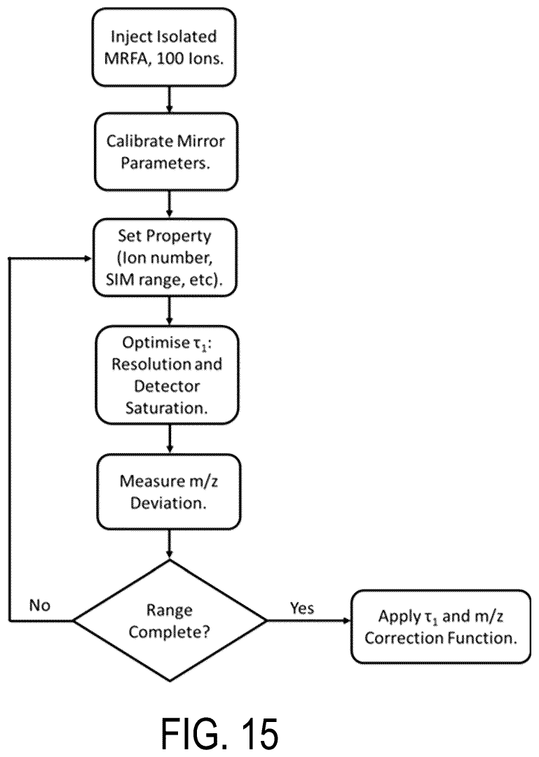

FIG. 15 show a flowchart for a more complex mirror calibration incorporating a shifted _{T}1 parameter for optimisation of behaviour that changes with some characteristic of the desired analytes. It may incorporate the full routine of FIG. 9A or 9B as the initial step “Calibrate Mirror Parameters.” Characteristics that may be adjusted for include m/z or pseudopotential well depth range, whether ions are isolated or not, ion number target (in-peak or in-trap, when some AGC process is active), etc. Desired target properties to optimise will normally include maximising resolution over the likely ion number range, but may also compromise this to give a maximum likely detector output, to prevent detector saturation, particularly at low m/z, and m/z shift.

The _{T}1 shift may be measured by a relatively quick scan of _{T}1 alone. Alternatively, a 2D scan of _{T}1 and ion energy would allow a more accurate targeting of both parameters, as effective energy offset may also shift. In theory, the full _{T}1, _{T}2 and energy calibration could be made for each property shift, though this may not be needed. Other methods of shifting the focal plane, equivalent to changing _{T}1, may also be utilised, for example a shift in the potential of all or part of the flight volume between the mirrors, possibly including the ground electrodes. A voltage variable post-accelerator attached to the detector may also accomplish this purpose, though only affects a small part of a single oscillation and so may require a very strong voltage change to achieve a significant difference.

Shifting mirror parameters typically also induces an m/z shift. One advantage of using small _{T}1 scans is that the m/z shift is small enough that non-isolated peaks may be easily tracked. The mass calibration may then be adjusted to take account of whatever differing _{T}1 is used. In FIG. 15, this is shown as simply measuring the m/z deviation, for a single or several calibrant ions, and applying a simple correction or fitted correction function. Such a function could be relatively simple, such as a linear or polynomial trend. If only two values of _{T}1 are used then only a step is required, and a full mass calibration could be performed for both values and may switch coefficients with them. A complex series of mass calibrations, with interpolation of coefficients between calibration _{T}1 points, is also possible.

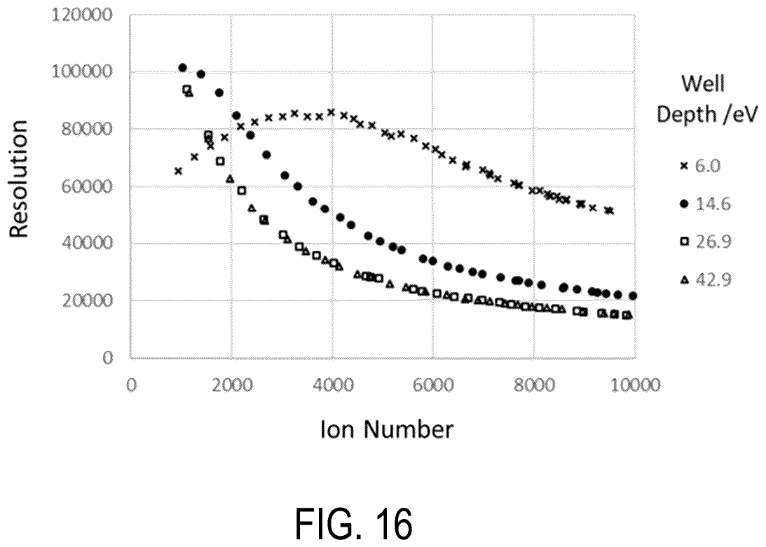

Instead of adjusting mirror/energy parameters to handle differing space charge behaviour for SIM/Full-MS and with ion number, the ion cloud prior to injection (in the trap, if a trapping method used) may be deliberately expanded or contracted to alter the in-peak space charge effects. FIG. 16 is reproduced from GB2612574 and shows the resolution shift of isolated m/z 524 ion under increasing number of ions in peak, and with different RF pseudopotential well depths. FIG. 16 shows how reducing the ion trap well depth (via lowered RF amplitude) increases the tolerance to high space charge of isolated MRFA ions. Similarly, a low m/z additive such as fluranthene internal calibrant ions from a secondary ion source, may be introduced to increase in-trap space charge effects. The advantage of this method is that it does not greatly adjust the mass calibration, or in the case of altering RF amplitude, likely already has a suitable m/z measurement correction in place. Reducing RF amplitude at the point of extraction is possible, although doing this during injection of ions into the trap may come at some cost to trapping efficiency.

Returning to the general terms used previously, space charge effects can be controlled using the methods described herein. For example, determining the set of calibrated operating parameters may comprise determining the value of the first tuning parameter based on a number of ions injected into the mass analyser. A detector capable of counting ions may be provided in the mass spectrometer. The values of the first tuning parameter can be tuned depending on how many ions are to be injected.

In some embodiments, the methods described herein may be performed for a plurality of peaks containing different numbers of ions. For example, the method may further comprise: determining a plurality of measures of signal quality for the mass analyser using the plurality of peaks (i.e. one measure of signal quality may be determined for each peak); determining a relationship (e.g. a trend) between the measures of signal quality and the numbers of ions; and determining the value of the first tuning parameter for the calibrated operating parameters based on the relationship between the measure of signal quality and the number of ions. The measures of signal quality may comprise measures of resolving power and/or detector saturation, although other ways of quantifying signal quality can be employed. In this way, if it is known that a certain sample would be affected by space charge effects, these can be pre-empted and compensated (at least to some extent) by a corresponding adjustment of the first tuning parameter so as to mitigate the space charge effects.

The methods described herein may be performed for a plurality of calibrant peaks, the plurality of calibrant peaks measured using different values of the first tuning parameter and/or containing different numbers of ions. The methods may further comprise: determining a plurality of mass-to-charge ratio shifts for the mass analyser using the plurality of calibrant peaks (i.e. determining differences between observed m/z values and the known m/z values of the calibrant); determining a relationship (e.g. a function) between the plurality of mass-to-charge ratio shifts and the values of the first tuning parameter and/or the numbers of ions; determining a mass-to-charge ratio shift correction function for the mass analyser based on the relationship between the plurality of mass-to-charge ratio shifts and the values of the first tuning parameter and/or the numbers of ions. This function may be stored for future use or recorded for offline processing. Alternatively the method may further comprise configuring the mass analyser to apply the mass-to-charge ratio shift correction function during operation. This method can allow corrections of mass-to-charge ratio shifts to be made when it is known that either the number of ions in a peak or the specific value of the first tuning parameter will lead to inaccurate m/z values being measured. Accordingly, accuracy may be increased.

It will be understood that many variations may be made to the above systems and methods whilst retaining the advantages noted previously. For example, where specific components have been described, alternative components can be provided that provide the same or similar functionality.

In various embodiments, causing the mass analyser to operate with the calibrated operating parameters may cause the ion mirror to provide at least third-order time-of-flight focusing.

While ion traps have been described extensively, any ion injection device can be used, such as an ion trap or an orthogonal extractor. Offsets can be applied to electrodes of the ion mirrors to accelerate ions to various different ion energies. Applying a plurality of acceleration voltages to ions to cause the ions to exit an ion injection device may involve changing of the ion mirror system offset instead of an ion trap offset.

In addition to methods of performing calibration, the present disclosure also provides apparatus configured to automatically perform the calibration routines described herein. A time-of-flight (ToF) mass analyser comprising an ion injection device and an ion mirror comprising a plurality of electrodes, the ToF mass analyser configured to perform the methods described herein. The ToF mass analyser may comprise a controller programmed to measure ion counts and m/z ratios and to adjust the ion energies and electrode voltages in accordance with the methods described herein. Also provided are computer programs and computer-readable media for causing ToF mass analysers to perform the methods described herein.

The present disclosure also provides a method for calibrating a time-of-flight (ToF) mass analyser, comprising: determining an initial set of operating parameters (e.g. pre-determined or simulated optimal parameters) for the mass analyser, the set of operating parameters comprising N operating parameters (e.g. voltages applied to electrodes and ion acceleration voltages) defining an N-dimensional parameter space; determining a set of M perturbation vectors in the parameter space, wherein M is less than N, by: defining one or more constraints on aberrations in the mass analyser; and determining the set of perturbation vectors based on the initial set of operating parameters and the one or more constraints on aberrations in the mass analyser; and calibrating the mass analyser by varying the operating parameters of the mass analyser about the initial set of operating parameters in a direction of at least one (and preferably each) of the perturbation vectors. Determining vectors in the parameter space by imposing constraints on aberrations can reduce the number of parameters that need to be tuned, which increases efficiency. This approach can be incorporated into any of the methods described herein.

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” (such as an electrode or an aberration) means “one or more” (for instance, one or more electrodes, or one or more aberrations). Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

1. A method for calibrating a time-of-flight (ToF) mass analyser comprising an ion injection device and an ion mirror comprising a plurality of electrodes, the method comprising:
applying a plurality of acceleration voltages to cause ions to exit the ion injection device to provide to the mass analyser ions having a respective plurality of ion energies;
at each ion energy, measuring the resolving power of the mass analyser with a plurality of sets of electrode voltages applied to the electrodes by varying a first tuning parameter to a respective plurality of values, wherein the first tuning parameter parameterises the electrode voltages applied to the plurality of electrodes;
determining maximising values of the first tuning parameter for each of the plurality of ion energies at which the resolving power is maximised;
identifying a point of inflection in the dependence of the maximising values of the first tuning parameter on the ion energies;
determining a set of calibrated operating parameters for the mass analyser based on the point of inflection, the set of calibrated operating parameters comprising a calibrated set of electrode voltages; and
causing the mass analyser to operate with the calibrated operating parameters.

2. The method of claim 1, wherein applying the plurality of acceleration voltages and/or the plurality of sets of electrode voltages comprises: varying the ion energies about a predetermined optimal value of the ion energy; and/or varying the first tuning parameter about a simulated optimal value of the first tuning parameter that corresponds to predetermined optimal values of the set of electrode voltages.

3. The method of claim 2, wherein the calibrated set of electrode voltages is based on the predetermined optimal values of the electrode voltages varied by the maximising value of the first tuning parameter corresponding to the point of inflection, and preferably varied by a maximising value of a second tuning parameter corresponding to the point of inflection.

4. The method of claim 1, wherein the set of calibrated operating parameters comprise a calibrated acceleration voltage corresponding to the ion energy at the point of inflection.

5. The method of claim 1, wherein the set of calibrated operating parameters comprise a calibrated acceleration voltage and wherein the method further comprises scaling the calibrated set of electrode voltages such that the calibrated acceleration voltage has a pre-determined value.

6. The method of claim 1, wherein varying the first tuning parameter causes a change in a time-of-flight aberration in the mass analyser.

7. The method of claim 6, wherein varying the first tuning parameter causes a change in a first-order time-of-flight aberration in the mass analyser while substantially not causing a change in at least one further aberration in the mass analyser.

8. The method of claim 7, wherein the at least one further aberration comprises any one or more of: second-order time-of-flight aberrations with respect to ion energy; second-order time-of-flight aberrations with respect to ion coordinates; and parallel-to-point spatial focusing of ions.

9. The method of claim 1, further comprising measuring the resolving power of the mass analyser at a plurality of values of a second tuning parameter, wherein the second tuning parameter parameterises the electrode voltages applied to the plurality of electrodes.

10. The method of claim 9, comprising measuring the resolving power of the mass analyser at the plurality of values of the second tuning parameter for each of the plurality of ion energies and for each of the plurality of sets of electrode voltages.

11. The method of claim 9, wherein varying the second tuning parameter causes a change in a second-order time-of-flight aberration in the mass analyser.

12. The method of claim 9, wherein varying the second tuning parameter causes a change in a time-of-flight aberration in the mass analyser while substantially not causing a change in at least one other aberration in the mass analyser.

13. The method of claim 12, wherein the at least one other aberration in the mass analyser comprises any one or more of: first-order time-of-flight aberrations with respect to ion energy; second order time-of-flight aberrations with respect to ion coordinates; and parallel-to-point spatial focusing of ions.

14. The method of claim 9, wherein determining the set of calibrated operating parameters comprises determining an optimal value of the second tuning parameter at which the maximising values of the first tuning parameter have a first derivative of substantially zero with respect to the plurality of ion energies at the point of inflection.

15. The method of claim 14, comprising determining the optimal value of the second tuning parameter based on the derivative of the maximising values of the first tuning parameter with respect to ion energy at the point of inflection.

16. The method of claim 14, wherein determining the optimal value of the second tuning parameter comprises:
determining the derivative of the maximising first tuning parameter with respect to ion energy at the point of inflection;
determining the derivative at a plurality of values of the second tuning parameter; and
determining the optimal value of the second tuning parameter based on interpolating the derivative at the plurality of values of the second tuning parameter.

17. The method of claim 9, wherein the first tuning parameter, and optionally the second tuning parameter, correspond to a parameterisation of the electrode voltages based on aberrations in the mass analyser.

18. The method of claim 17, wherein the aberrations comprise any one or more of: first-order time-of-flight aberrations with respect to ion energy; second-order time-of-flight aberrations with respect to ion energy; second-order time-of-flight aberrations with respect to ion coordinates; and parallel-to-point spatial focusing of ions.

19. The method of claim 17, wherein the parameterisation is a linear parameterisation.

20. The method of claim 17, wherein the parameterisation is based on a series expansion of the aberrations in the mass analyser.

21. The method of claim 17, wherein the parameterisation expresses the electrode voltages in terms of:
predetermined optimal values of the set of electrode voltages;
the first tuning parameter; and
a vector in the space of electrode voltages corresponding to the first tuning parameter; and
preferably a second tuning parameter and a vector in the space of electrode voltages corresponding to the second tuning parameter.

22. The method of claim 1, wherein causing the mass analyser to operate with the calibrated operating parameters causes the ion mirror to provide at least third-order time-of-flight focusing.

23. The method of claim 1, wherein determining the set of calibrated operating parameters comprises determining the value of the first tuning parameter based on a number of ions injected into the mass analyser.

24. The method of claim 1, wherein the method is performed for a plurality of peaks containing different numbers of ions, the method further comprising:
determining a plurality of measures of signal quality for the mass analyser using the plurality of peaks;
determining a relationship between the measures of signal quality and the numbers of ions; and
determining the value of the first tuning parameter for the calibrated operating parameters based on the relationship between the measure of signal quality and the number of ions.

25. The method of claim 24, wherein the measures of signal quality comprise measures of resolving power and/or detector saturation.

26. The method of claim 1, wherein the method is performed for a plurality of calibrant peaks, wherein the plurality of calibrant peaks are measured using different values of the first tuning parameter and/or contain different numbers of ions, the method further comprising:
determining a plurality of mass-to-charge ratio shifts for the mass analyser using the plurality of calibrant peaks;
determining a relationship between the plurality of mass-to-charge ratio shifts and the values of the first tuning parameter and/or the numbers of ions;
determining a mass-to-charge ratio shift correction function for the mass analyser based on the relationship between the plurality of mass-to-charge ratio shifts and the values of the first tuning parameter and/or the numbers of ions; and
configuring the mass analyser to apply the mass-to-charge ratio shift correction function during operation.

27. The method of claim 1, wherein the ion injection device comprises an ion trap or an orthogonal extractor.

28. A time-of-flight (ToF) mass analyser comprising an ion injection device and an ion mirror comprising a plurality of electrodes, the ToF mass analyser configured to perform the method of claim 1.

29. A computer program comprising instructions configured to cause a time-of-flight (ToF) mass analyser comprising an ion injection device and an ion mirror comprising a plurality of electrodes to execute the steps of the method of claim 1.

30. A computer-readable medium having stored thereon the computer program of claim 29.
